(19) United States
(12) Patent Application Publication
(10) Pub. No.: US 2009/0089132 A1
(43) Pub. Date: Apr. 2, 2009

(54) Computer-Assisted Contract Management System for An Enterprise

(75) Inventors: Murali Nallapaty, Milford, OH (US); Christina Underwood, Cincinnati, OH (US)

Correspondence Address: THOMPSON HINE L.L.P.;Intellectual Property Group, P.O. BOX 8801, DAYTON, OH, 45401-8801, US

(73) Assignee: The Kroger Co., Cincinnati, OH (US)

(21) Appl. No.: 11/864,249

(22) Filed: Sep. 28, 2007

(51) Int. Cl. G06Q 10/00; G06F 17/30; G06F 17/40

(52) U.S. Cl. 705/9; 705/8

(57) ABSTRACT

A computer-assisted management method for an enterprise including multiple work locations is provided. The method includes creating electronic contracts by associating work rules within the electronic contracts, the work rules governing an employer-employee relationship. The electronic contracts including the work rules are stored in a contract database. The electronic contracts stored in the contract database are provided to one or more system. The employer-employee relationship is managed using the electronic contracts including the work rules.

### TECHNICAL FIELD

The present application relates to a computer-assisted contract management system for an enterprise.

### BACKGROUND

Enterprises, such as retail enterprises, typically include numerous employees located at various stores located across the country and, in some cases, even at a number of different countries. Often times, the employer-employee relationship includes employment contracts, policies and/or procedures of the company that define rules governing the relationship. Contracts, policies, procedures and/or practices applicable to various employees may differ, for example, based on the status of the particular employee, the requirements of any labor union to which the employee belongs, the department in which the employee works, the location where the employee works, etc. It would be desirable to provide a computer-assisted method and system that provides the ability to capture and maintain applicable rules governing the employer-employee relationship across the enterprise.

### SUMMARY

In an aspect, a computer-assisted management method for an enterprise including multiple work locations is provided. The method includes creating electronic contracts by associating work rules within the electronic contracts, the work rules governing an employer-employee relationship. The electronic contracts including the work rules are stored in a contract database. The electronic contracts stored in the contract database are provided to one or more system. The employer-employee relationship is managed using the electronic contracts including the work rules.

In another aspect, a computer-assisted management method for an enterprise including multiple work locations is provided. The method includes generating a first task for a contract administrator, the contract administrator creating an electronic contract in response to the first task. A second task is generated for an approver who is different from the contract administrator, the approver approving the electronic contract created by the contract administrator in response to the second task. The electronic contract is stored in a contract database.

In another aspect, a computerized employee management method for an enterprise including multiple locations and multiple contracts is provided. The method includes, for each contract, (i) storing contract data in a electronic contract database and (ii) associating the contract data with the enterprise hierarchy so as to define to which enterprise locations and enterprise employees the contract data apply. The contract database may be linked with an employee on-boarding application to facilitate proper classification of new enterprise employees within the applicable electronic contract. The electronic contract database is linked with one or more enterprise payroll or other administrative system to facilitate appropriate employee management for enterprise employees according to the applicable electronic contract.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a diagrammatic illustration of an embodiment of a management system;

FIG. 2 is a diagrammatic illustration of an embodiment of an electronic contract structure;

FIG. 3 is an embodiment of a workflow diagram for creating an electronic contract;

FIG. 4 is an exemplary screenshot showing a number of tasks awaiting action by a system administrator;

FIG. 5 illustrates an embodiment of a Task Details screen;

FIG. 6 illustrates an embodiment of an Add Contract Wizard screen;

FIG. 7 illustrates an embodiment of a workflow diagram for entering an electronic contract;

FIG. 8 illustrates an embodiment of a Basic Information screen for entering basic contract information;

FIG. 9 illustrates an embodiment of an Add Rule screen where a work rule can be added;

FIG. 10 illustrates an embodiment of a Rule Details screen for use in adding Status Progression Rule information;

FIG. 11 illustrates an embodiment of a Rule Validation screen for a Status Progression Rule;

FIG. 12 illustrates an embodiment of a Errors Screen Display for a Status Progression Rule;

FIG. 13 illustrates an embodiment of an UPHW Rules screen for adding an UPHW Rule;

FIG. 14 illustrates an embodiment of a Rules Parameter section for adding an UPHW Rule;

FIG. 15 illustrates an embodiment of a Paid Time Off Rule screen for adding or editing Paid Time Off Rules;

FIG. 16 illustrates an embodiment of a Level Details screen for adding or editing Paid Time Off Rules;

FIG. 17 illustrates an embodiment of a Calculation Basis section for adding or editing Paid Time Off Rules;

FIG. 18 illustrates another embodiment of a Calculation Basis section for adding or editing Paid Time Off Rules;

FIGS. 19 and 20 illustrate tabs of an embodiment of a Tiers screen;

FIG. 21 illustrates an embodiment of a Wizard screen for adding a Time and Attendance Rule;

FIG. 22 illustrates an embodiment of a screen for adding a Time and Attendance Daily Rule;

FIG. 23 illustrates an embodiment of a screen for adding a Time and Attendance Pay Period Rule;

FIG. 24 illustrates an embodiment of a Company Benefits Rule screen for adding a Company Benefits Rule;

FIG. 25 illustrates an embodiment of a Wage Progression Add/Edit Rule screen for adding a Wage Progression Rule;

FIG. 26 illustrates an embodiment of a Contract List Report screen that allows a user to obtain a list of electronic contracts;

FIG. 27 illustrates an exemplary Contract List Report;

FIG. 28 illustrates en exemplary Contract Summary Report Search screen;

FIG. 29 illustrates an exemplary Contract Summary Report Wizard screen;

FIG. 30 illustrates an exemplary Contract Audit Log Report;

FIG. 31 illustrates an embodiment of a Contract History Report;

FIG. 32 illustrates an embodiment of a search screen for use in identifying a user;

FIG. 33 illustrates an exemplary User List Report;

FIG. 34 illustrates an embodiment of a search screen for finding an electronic contract with scheduled changes;

FIG. 35 illustrates an embodiment of a wizard screen that allows a user to select various reporting parameters to find electronic contracts with scheduled changes;

FIG. 36 illustrates an exemplary Scheduled Changes Report;

FIG. 37 illustrates an exemplary Synchronization Log Report;

FIG. 38 illustrates an exemplary System Configurations screen for system administration; and

FIG. 39 illustrates an embodiment of a system architecture.

### DETAILED DESCRIPTION

For the purposes of describing one or more embodiments, this description will discuss a large retail supermarket. This discussion of a large retail supermarket is merely exemplary in nature and is in no way intended to limit the invention, its application, or uses and alternatively this invention can be used in other retail, wholesale or service enterprises. For example, the method and system described below may be used in non-retail work locations such as manufacturing plants, floral processing centers and distribution centers.

An enterprise is a number of work locations including stores that may be grouped by geographical or corporate characteristics, such as divisions. Divisions may be defined by geographical location, type of store, e.g. a convenience store or a superstore, or demographics, e.g. rural, urban or suburban. In addition, the demographic profiles of store customers may be used to group stores (e.g. a suburban middle class neighborhood or a suburban upper income neighborhood). As used herein, a store can be a retail outlet, wholesale outlet or other physical location where transactions involving goods or services occur between the customer and the enterprise.

Locations may be subdivided into smaller sections or departments to more effectively control and track their revenues and expenses. Examples of departments within a typical supermarket can include the meat department, pharmacy department, grocery department, produce department, frozen foods department, bakery and the like.

The management system and method developed herein provides for interactive, centralized contract management and rules administration through the ability to capture and maintain employment contracts, policies, procedures and practices (collectively defining rules) that, for example, determine employee benefits, status and compensation across an enterprise. The management system acts as a common repository for contract data that can be made available for other systems, such as payroll, manager self service, etc.

Management System Access

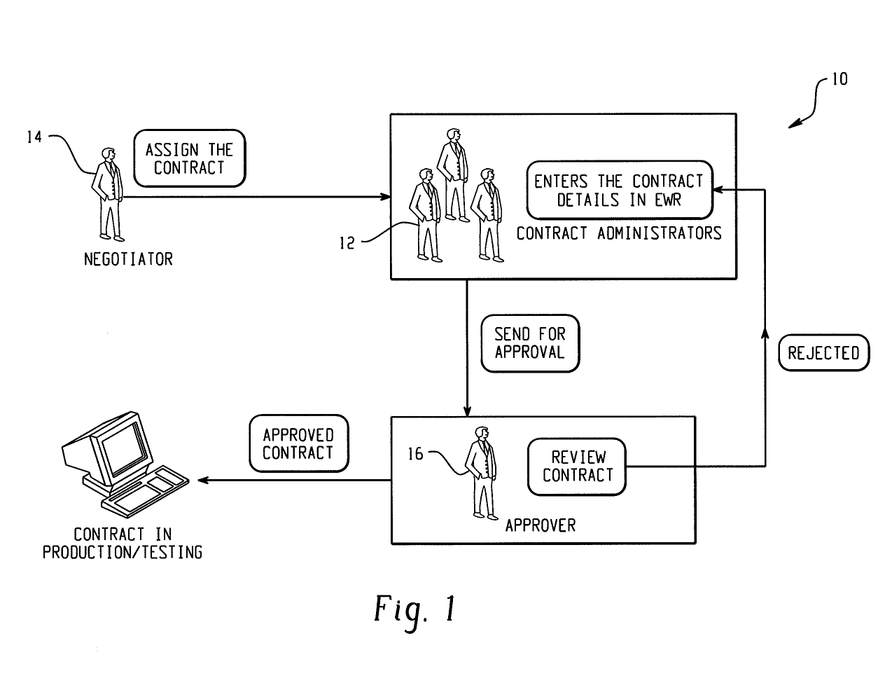

Referring to FIG. 1, access to the management system 10 is provided to different types of users having differing levels of access and functionality. A contract administrator 12 is a user who is assigned a task of adding and/or editing rules and/or associated employee data in the management system 10. As used herein, a collection of rules and data entered in the management system 10 and associated with an employee or group of employees is referred to as an electronic contract. In many instances, an electronic contract is associated with a group of employees. It should be noted, however, that the employer-employee relationship may not actually be governed by a formal contract, but may instead be governed by certain policies, procedures and/or practices of one or more organizations. In these instances, the electronic contract includes rules defined by these policies, procedures and/or practices.

A negotiator 14 is a user who determines contracts, policies, procedures and/or practices, is responsible for implementing new or changed rules and/or may create a task for the contract administrator 12 to add and/or edit the electronic contract. An approver 16 is a user who receives the electronic contract after it has been drafted by the contract administrator 12, reviews the detailed interpretation and approves or disapproves the electronic contract. A system administrator (not shown) is a user responsible for administrative setup and maintenance of the management system 10. A guest (not shown) is a casual user of the management system 10 and, in some embodiments, can only view and utilize selected functionalities of the management system. The management system 10 may be a protected, secure application having different access levels and different functionalities for the different users implemented using a user identifier and a password, for example. Based on the access rights, the user interface displayed may change.

Electronic Contract Structure

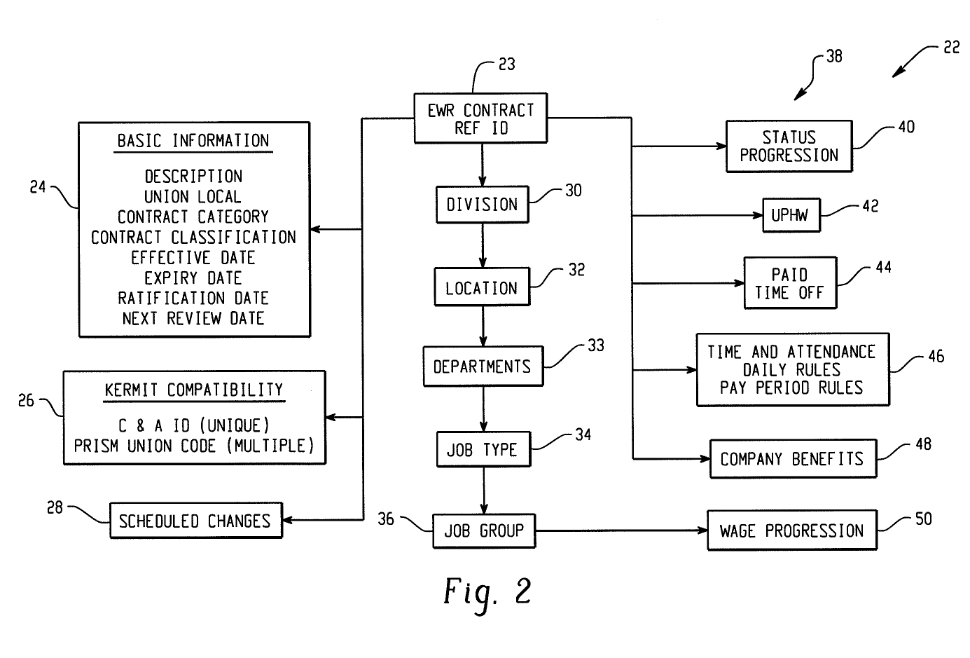

FIG. 2 illustrates an exemplary electronic contract structure 22 including pre-selected data identified from contracts, policies, procedures, practices, etc. Contract structure 22 includes a reference identifier 23 (e.g., that is automatically generated) that is used to identify the electronic contract and basic information 24. Basic information 24 includes a contract description, contract category (i.e., union or non-union), union Local involved in contract finalization, if applicable, Union involved in contract finalization, if applicable, effective date of the contract, expiration date of the contract, date the contract was ratified and the next review date for the contract. Contract structure 22 may also include data generally referred to as element 26 used by an external system, such as a payroll system, time and attendance tracking system, employee on-boarding application, etc. Scheduled change data 28 refers to wage, status and/or any revisions that may apply during the lifespan of the relationship and may apply in the context of contracts that expire after the effective date of the contract.

Division data 30 refers generally to a primary business unit for which the electronic contract is being added, location data 32 identifies various work locations within the division and department data 33 identifies the departments in each location. Each division, location and department has different jobs that have been assigned a job code and job code data 34 identifies the job associated with the contract. Job group data 36 identifies a logical grouping of job codes treated similarly under at least certain aspects of the electronic contract.

Column 38 includes various rule types that may be associated with the electronic contract and will be described in greater detail below. The rules may be defined by a formal contract, however, they may be defined by other sources such as internal policies and procedures, federal law governing unions (e.g., The Taft-Hartley Act), etc. The rule types include Status Progression Rules 40, UPHW Rules 42 which govern Union Pension and Health & Welfare (UPHW) Contribution Rules, Paid Time Off Rules 44, Time and Attendance Rules 46, Company Benefit Rules 48 and Wage Progression Rules 50.

Workflow Capability

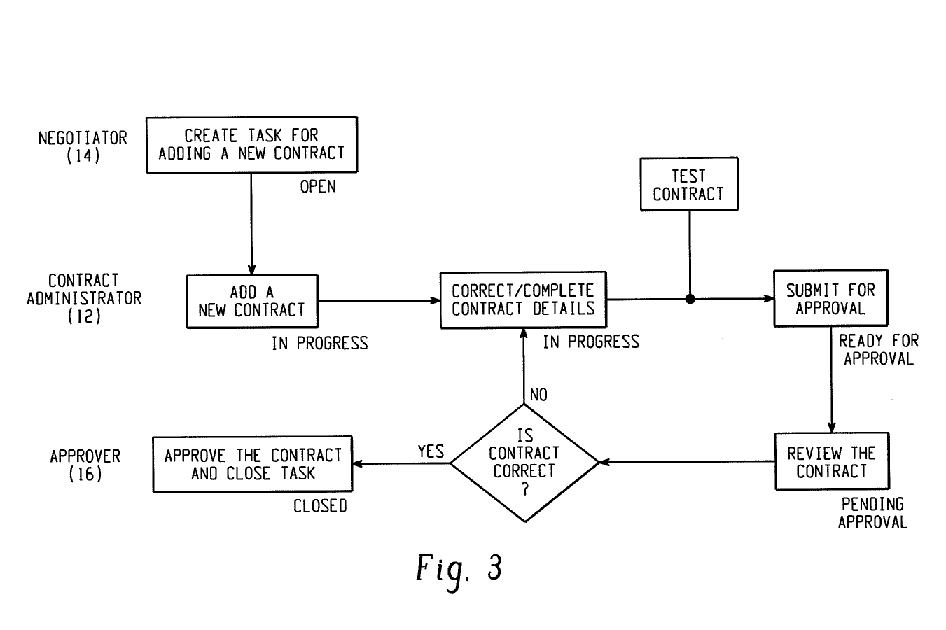

The management system 10 utilizes a workflow-based system for creating electronic contracts and modifying existing electronic contracts through use of tasks assigned to the various users. Referring to FIG. 3, a workflow 52 for adding a new electronic contract involves the negotiator 14, the contract administrator 12 and the approver 16. Once an employee relationship is negotiated by the negotiator 14, a task is created for the contract administrator 12 to enter contract data into the management system 10. Once the contract data is entered, the electronic contract is submitted for approval by the approver 16 as a task for the approver. The approver 16 then approves or rejects the electronic contract. If the electronic contract is rejected, a task is created for the contract administrator 12 to correct the electronic contract. If the electronic contract is approved by the approver 16, then the contract data is stored as an approved electronic contract.

In some embodiments, the workflow 52 includes a testing step 55 in which contract data is provided to a peripheral system for testing. This step 55 may be performed when the contract administrator 12 (or the approver 16) selects the test feature during which the electronic contract is exported to an interface file sent to the peripheral system (such as a payroll system) test environment. As one example, an XML file is generated and sent to a test queue. The peripheral system then translates the XML file into a usable file format for testing of work rules. A test process is performed that parallels the last production processing and the test results are compared to the last production processing and used to determine whether the work rules are correct.

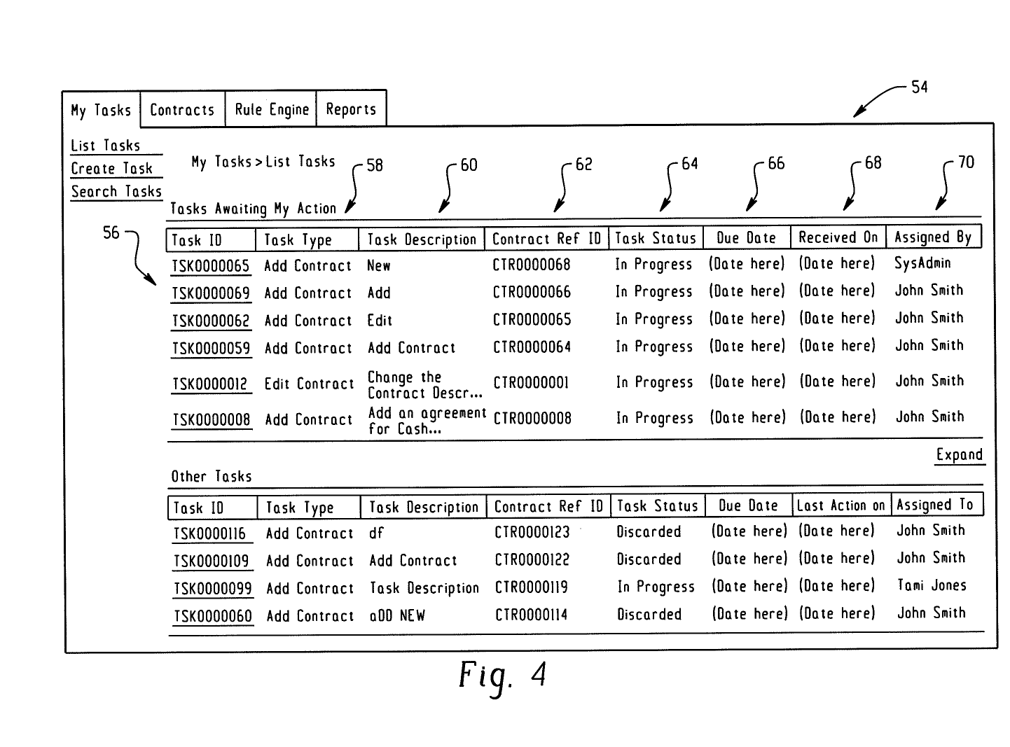

FIG. 4 illustrates an exemplary screenshot 54 that lists a number of tasks awaiting action by the contract administrator. Information listed includes a task ID number 56 associated with each task, a task type 58 indicating the task to be performed, a task description 60 which may include special instructions for the contract administrator, a contract reference identifier 62 that uniquely identifies the particular electronic contract, task status 64, due date 66 by which the task is to be completed, received on date 68 that the task was received, and assigned by field 70 identifying who assigned the task. As noted above, once a contract is negotiated by the negotiator, typically the negotiator will create an “Add Contract” task for the contract administrator. Also, if the approver does not approve the electronic contract, an “Edit Contract” task is typically created by the approver for the contract administrator. In some embodiments, the contract administrator (or other user assigned to the task) receives an e-mail notification indicating the newly created task. In some instances, an edit contract task may be created to revise or update work rules based on changed business rules. In some embodiments, multiple users may receive an e-mail notification when a task is created.

Creating an Electronic Contract

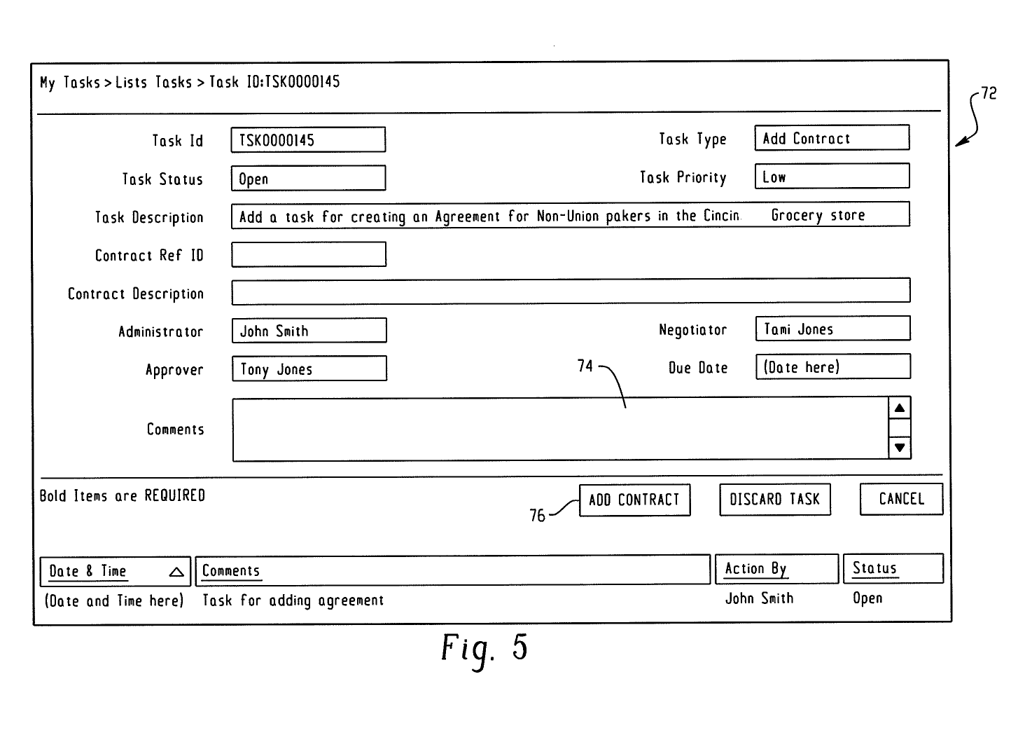

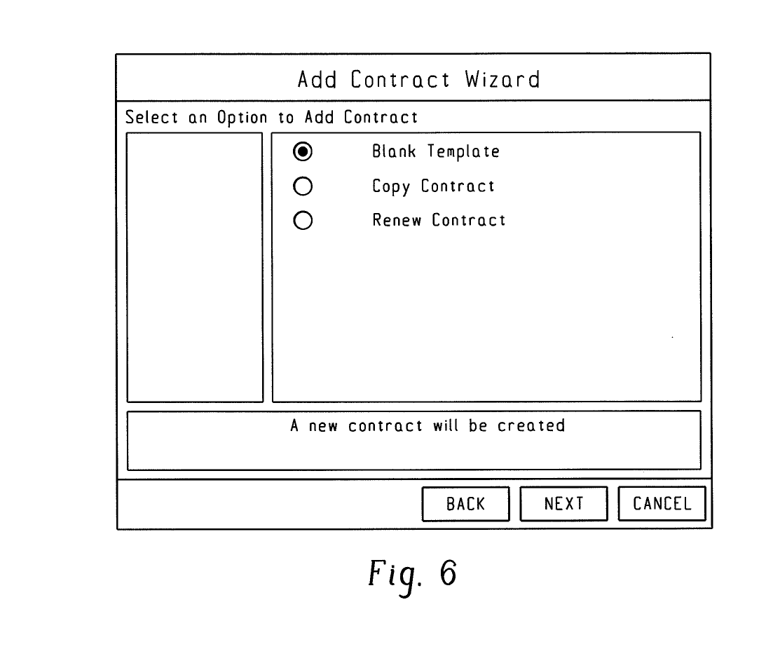

By clicking on the task ID number 56 of FIG. 4, a Task Details screen 72 of FIG. 5 displays where comments can be entered and associated with the electronic contract. Once any comments are entered within field 74, an add contract button 76 may be selected, which opens an add contract wizard. As used herein, a “wizard” is an interactive computer program which acts as an interface to lead a user through a task, for example, using step-by-step dialogs. Referring to FIG. 6, in this embodiment, the wizard aids the contract administrator in identifying and entering certain contract information. As shown by FIG. 6, a blank template allows for creation of a new contract, copy contract allows a contract to be copied from an existing contract and renew contract allows for creation of a contract by renewing an expired contract.

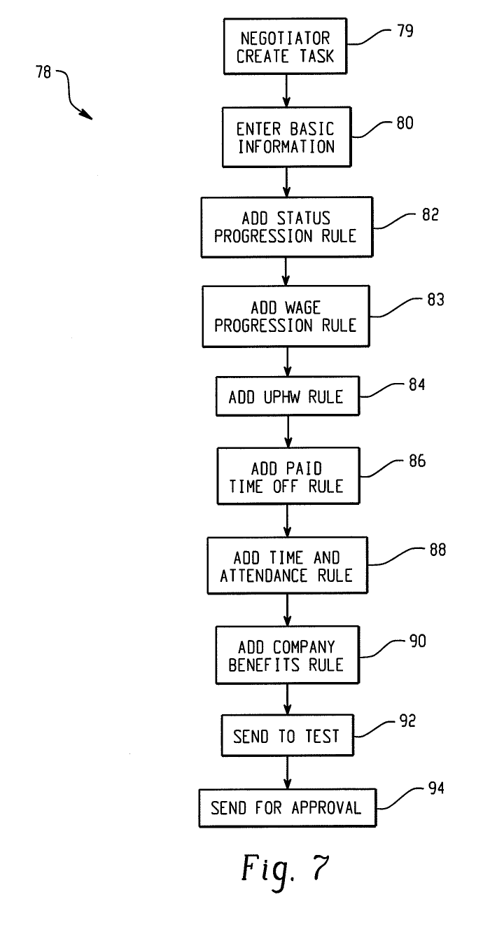

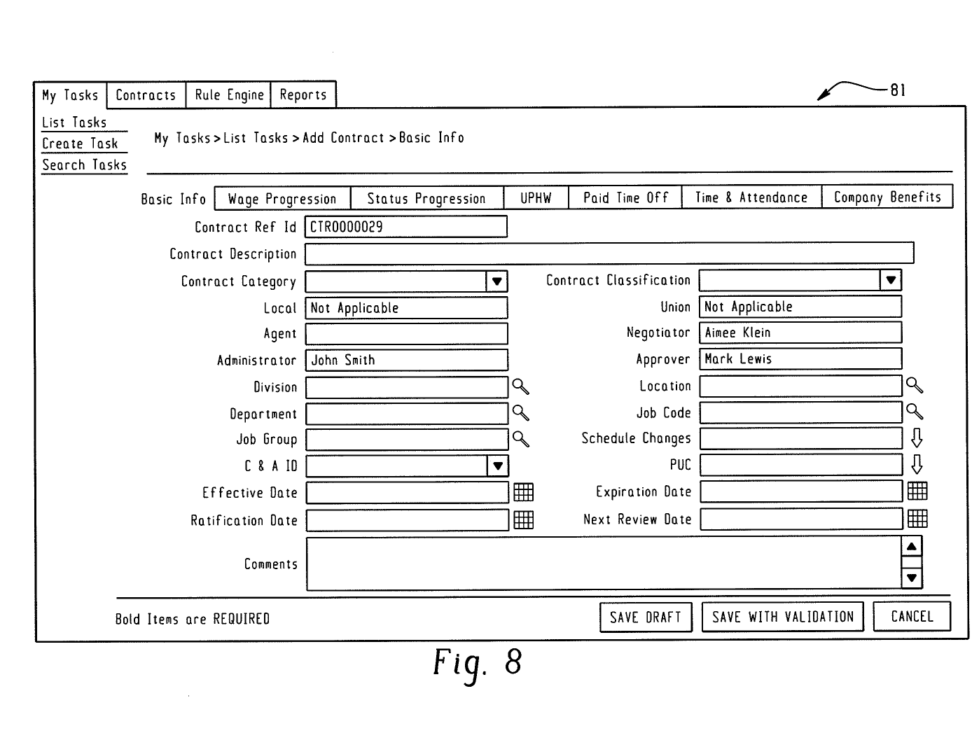

The process of creating an electronic contract includes several steps. FIG. 7 shows an exemplary workflow diagram 78 for creating an electronic contract. At step 79, a negotiator generates a task for a contract administrator. At step 80, basic information is entered in all fields of a Basic Information screen 81 (see FIG. 8) and the basic information is saved. At step 82, Status Progression Rules are added, associated with the electronic contract and saved. At step 83, Wage Progression rules are added, associated with the electronic contract and saved. At step 84, UPHW Rules are added, if required, associated with the electronic contract and saved. Paid Time Off Rules are added, if required, associated with the electronic contract and saved at step 86. At step 88, Time and Attendance Rules are added, if required, associated with the electronic contract and saved. At step 90, Company Benefits Rules are added, if required, associated with the electronic contract and saved. The entered information and rules are then tested at step 92 and a task is created at step 94 for the approver 16 to approve the validated electronic contract. The approver 16 or contract administrator 12 may test the electronic contract for correctness by sending contract data to a peripheral test system.

Electronic contracts and rules can be classified into two broad categories: created and imported. Imported electronic contracts and rules are electronic contracts and rules imported from another system (such as a payroll system) capable of communicating with the management system 10. Created electronic contracts and rules are those electronic contracts and rules created by the contract administrator using the management system 10. Users of the management system 10 can search all existing electronic contracts and rules (imported and created) in the system's repository.

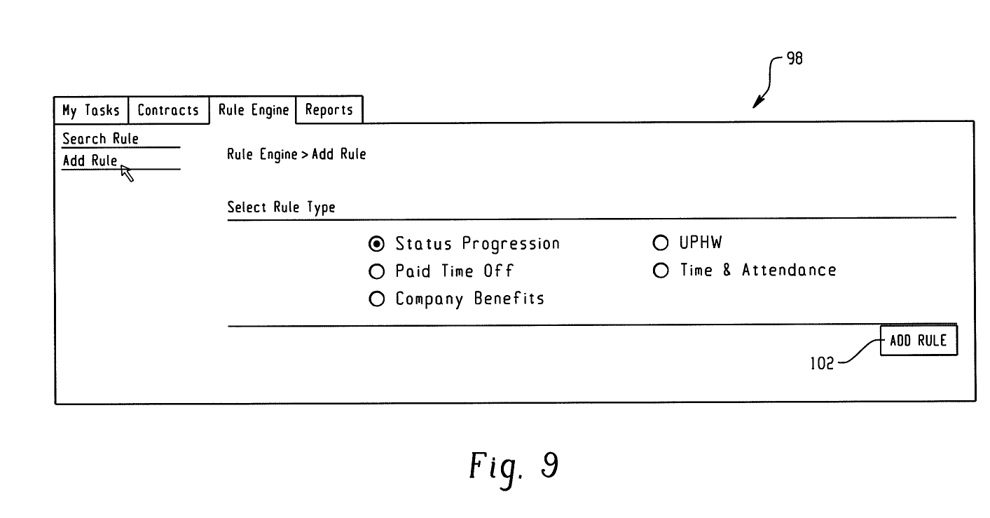

Referring to FIG. 9, rule wizards are used to aid the contract administrator in creating and associating rules with contracts. In some embodiments, rules (e.g., wage progression) may be created within contracts themselves and outside the rule wizard. FIG. 9 shows an Add Rule screen 98 of a rule engine module where a rule can be added. The contract administrator can select the type of rule from Status Progression, Paid Time Off, Company Benefits, UPHW and Time and Attendance by clicking an associated radio button. In this example, a Status Progression Rule is selected and selecting the Add Rule button 102 causes a rule details screen to display.

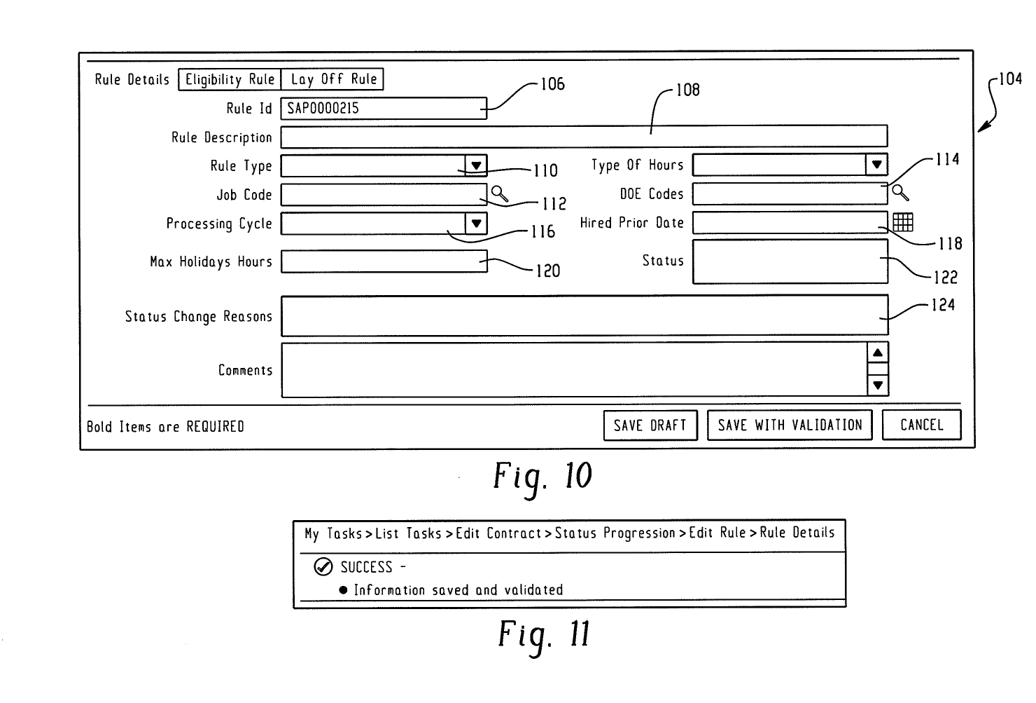

Referring to FIG. 10, a Rule Details screen 104 allows for adding Status Progression Rule information. A Rule ID field 106 displays an automatically generated unique identity for the rule. A Rule Description field 108 allows the contract administrator to enter or edit a description of the rule. A Rule Type drop-down list 110 allows for selection of a rule type, in this example, either a Qualification Rule or a Disqualification Rule. As will be described, there are different rule options associated with each of the Qualification Rule or the Disqualification Rule. Other data can be associated with the rule, such as Job Code 112, Deductions and Earnings Code (DOE) 114, Processing Cycle 116 (e.g., every period, every week, every quarter, etc.), Hired Prior Date 118, etc. A Max Holiday Hours 120 field allows for entry of a maximum amount of holiday hours that should be used in an average or total hours calculation within this rule. A Status field 122 allows for entry of a status (e.g., full time, full time probationary, part time regular, etc.) associated with this rule. A Status Change Reasons field 124 allows for entry of a rule for when status of the employee changes. For example, if the contract administrator selects Qualification Rule, the following status change reasons may become valid, as examples: Increased to Fulltime; Qualified for Regular Status; Promoted to Fulltime; Requalified for Regular Status. If the contract administrator selects Disqualification Rule, the following status change reasons may become valid, as examples: Reduced to Part Time; Lost Regular Status; Reduced from Fulltime Regular to Part Time Regular. The contract administrator can add parameters associated with any of the above status change selections and the Status Progression Rule, once completed, can be saved and associated with the particular electronic contract.

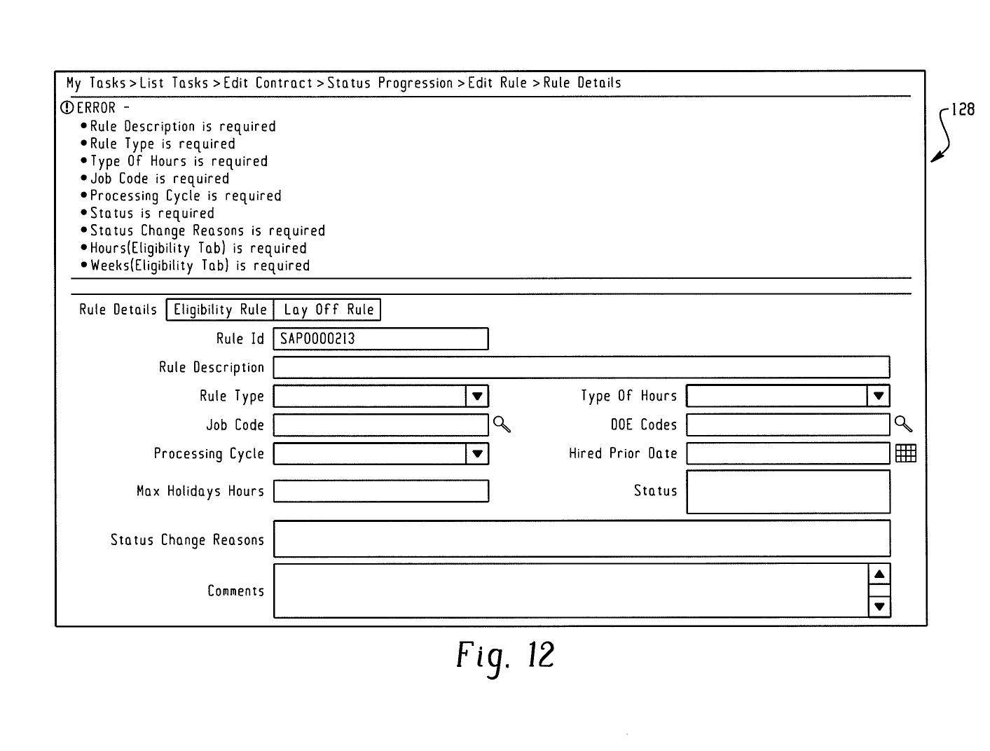

Referring to FIG. 11, once the contract administrator has entered the data including any rule parameters, then the rule may be validated against system rules indicating valid conditions saved by selecting a Save with Validations button 126 (FIG. 10). For example, the management system 10 may check whether all mandatory fields are entered. FIG. 12 shows an exemplary Errors Screen display 128 where the management system displays any reasons for determining that validation is unsuccessful. In some embodiments, if the management system determines that the validation is unsuccessful, then the rule is saved as a draft. Based on the Error Screen display 128, the contract administrator may enter or re-enter any of the rule information.

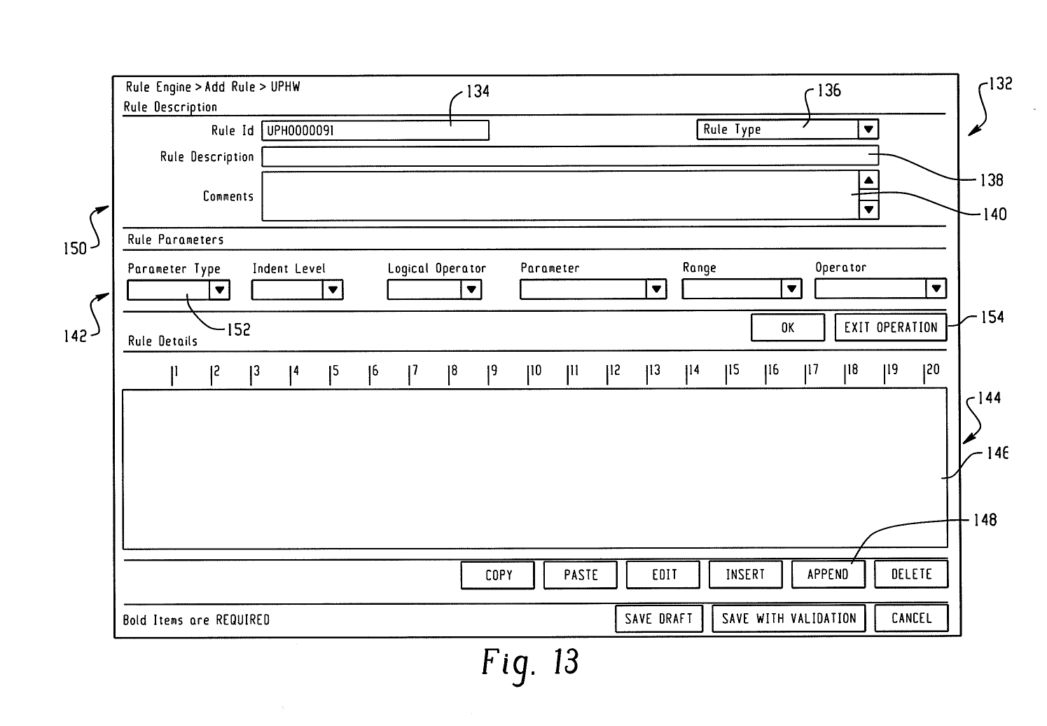

Referring to FIG. 13, various benefits may be provided to each employee, such as pension or health and welfare benefits. UPHW Rules are used to calculate company contributions due and, in some instances, eligibility for a group of employees for the benefits. UPHW Rules may be added or edited from screen 132. A Rule ID field 134 displays an automatically generated unique identity for the rule. A Rule Type drop-down list 136 allows for selection of a rule type such as health and welfare, pension, etc. The contract administrator may enter a Rule Description in field 138 and comments in a Comment field 140.

Rule Parameters section 142 is used by the contract administrator to add rule rows or modify rule rows in a Rule Details section 144 for constructing the UPHW rule. Various drop-downs and fields display depending upon parameters selected. The Rule Parameters section 142 includes a sequence of rule parameters that, in this embodiment, display different options as drop-down lists. The drop-down lists may be enabled in a sequential manner, with their displayed parameters changing based on the parameter selected in the preceding drop-down list.

The Rule Details section 144 displays an area 146 for adding and/or editing rule rows that make up the UPHW Rule. The Rule Details section 144 displays different indent levels for the rule rows, which aids in reading the rows of logic as will be described below. If a new UPHW Rule is being created, initially area 146 is blank. If a UPHW Rule is being copied or edited, the area 146 is populated by rule rows of the UPHW Rule being copied or edited.

An exemplary process for adding a new UPHW Rule begins by entering inputs in the fields in Rule Description Section 150, such as Rule Type 136 and Rule Description 138 and then selecting the Append button 148. When the Append button 148 is selected, a Parameter Type drop-down list 152 and an Exit Operation button 154 become enabled and the Append button 148 is disabled.

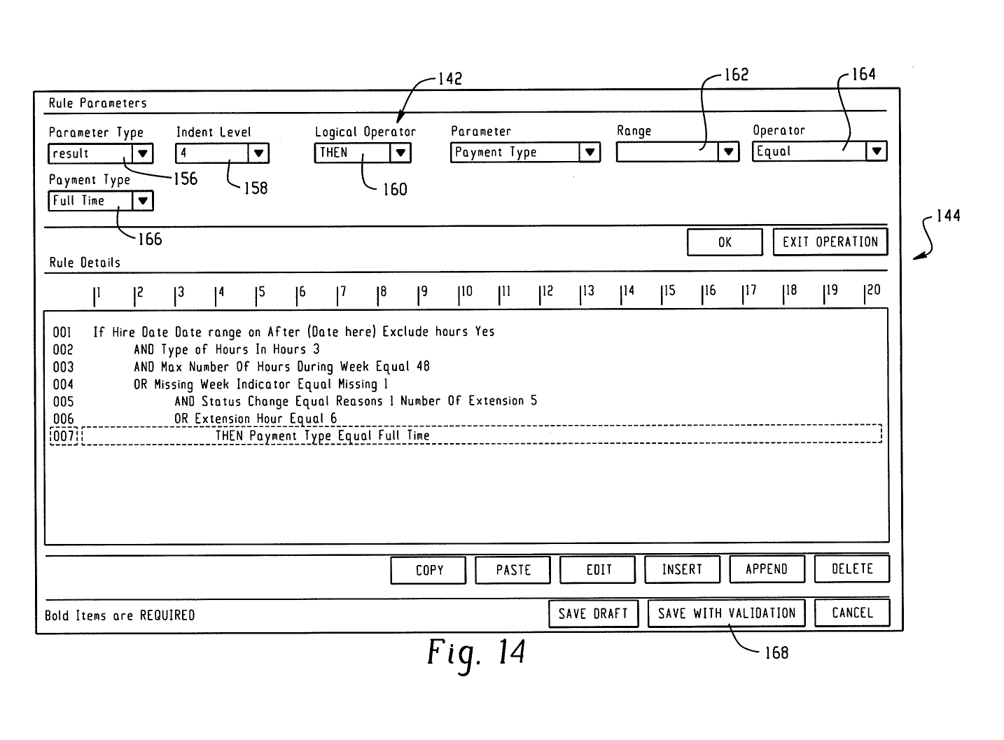

Referring now to FIG. 14, Rules Parameters section 142 is used to occupy rows (e.g., 001) in the Rule Details section 144 to formulate a new UPHW Rule. In the illustrated embodiment, the Rules Parameters section 142 includes Parameter Type drop-down list 156, Indent Level drop-down list 158, Logical Operator drop-down list 160, Range drop-down list 162, Operator drop-down list 164 and Payment Type drop-down list 166. The contract administrator can add successive rows by selecting values in the Rules Parameter section 142. In some embodiments, a UPHW Rule starts with a selection parameter and ends in a result. Rule rows, once created, can be copied, pasted, edited, inserted, deleted, etc. The created UPHW Rules can be saved as draft non-validated rules or validated and saved rules. Selecting a Save with Validations button 168 causes the system to validate the UPHW Rule against business rules saved. If the validation is successful, then a rule status for the UPHW Rule is changed to validated. If the validation is unsuccessful, then an error message displays with the erroneously entered field highlighted in bold red color. If the rule is not validated, its status remains as a draft.

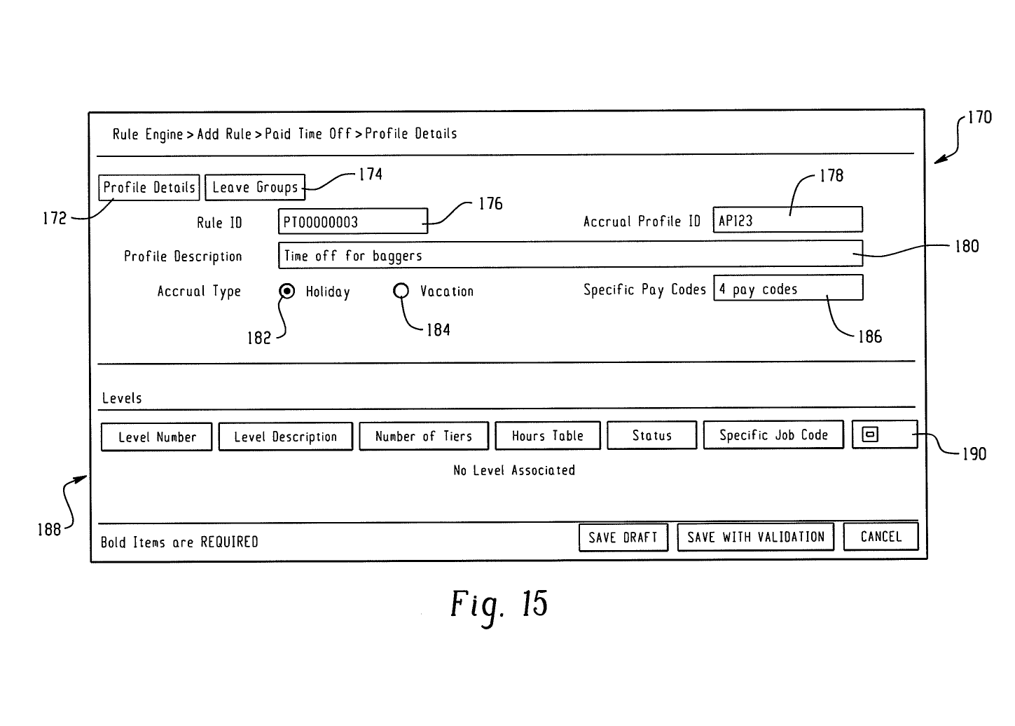

Referring to FIG. 15, paid time off is a company policy or contractually-negotiated benefit where an employee is awarded payment for time that he/she does not physically perform any work for the company. FIG. 15 shows an exemplary Paid Time Off Rule screen 170 for use in adding or editing Paid Time Off Rules. The Paid Time Off Rule screen 170 includes two tabs: Profile Details 172 and Leave Groups 174. Under the Profile Details tab 172, a Rule ID field 176 displays an identity number automatically generated by the system and an Accrual Profile ID field 178, which allows for entry of an identity number generated by the contract administrator. A Rule Description field 180 allows for entry of a description by the contract administrator. Buttons 182 and 184 allow for selection between two accrual types: holiday and vacation. A Specific Pay Codes field 186 allows for selection of a pay code to be associated with the Paid Time Off Rule.

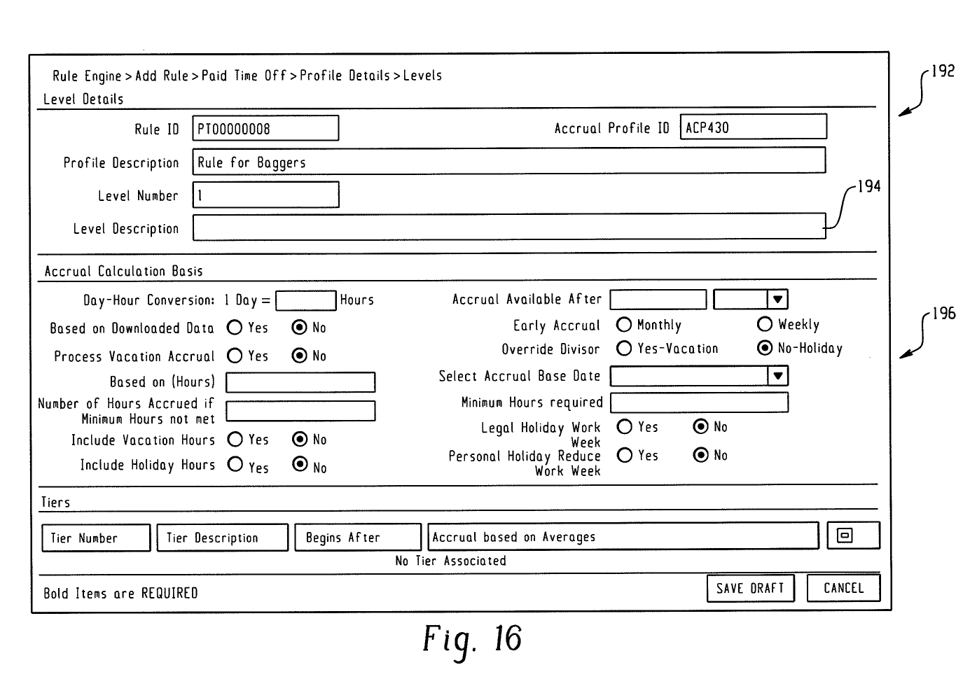

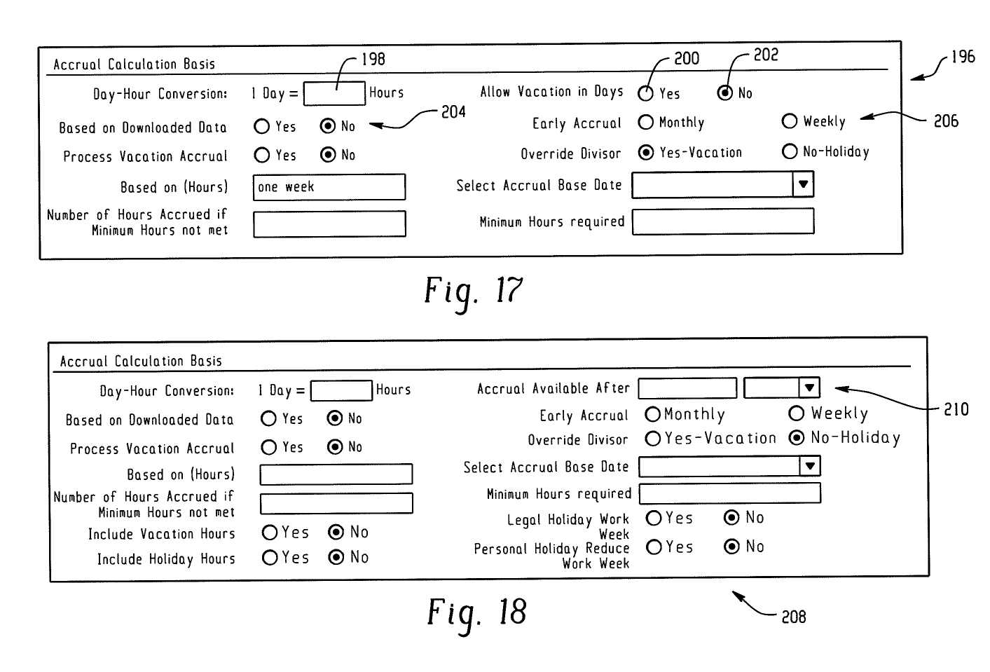

A Levels section 188 allows a level to be associated with the Paid Time Off Rule. By selecting button 190, a level can be created. Referring to FIG. 16, a Level Details screen 192 displays when button 190 is selected. Level Details screen 192 includes many of the fields from the Paid Time Off Rule screen 170 and further includes a Level Description Field 194 that is used by the contract administrator to describe the level. An Accrual Calculation Basis section 196 displays fields for deciding Paid Time Off accruals for the electronic contract with which the rule will be associated. In some embodiments, the display of the Accrual Calculation Basis section 196 changes with the accrual types selected from the Paid Time Off screen 170. For example, referring to FIG. 17, if the Vacation radio button 184 is selected from the Paid Time Off screen 170, the illustrated Accrual Calculation Basis section 196 displays. Accrual Calculation Basis section 196 includes a Day-Hour Conversion field 198 that allows the contract administrator to define how many hours are in a working day and buttons 200, 202 that determine whether a vacation is allowed to be taken in day increments. A Downloaded Data field 204 allows the contract administrator to choose whether the calculation of the accrual is based on data downloaded from another system. An Early Accrual field 206 displays options monthly and weekly that the contract administrator can select if the paid time off is to be accrued early on a weekly or a monthly basis.

Referring to FIG. 18, if Holiday radio button 182 is selected from the Paid time Off screen 170, Accrual Calculation Basis section 208 is displayed. Accrual Calculation Basis section 208 includes some of the fields displayed in Calculation Basis section 196 and also includes an Accrual Available After field 210 that allows the contract administrator to decide the worked period after which the paid time off can be accrued. Other fields are also included that allow for further definition of the rule. Once the level is fully defined, it can be saved while checking for errors.

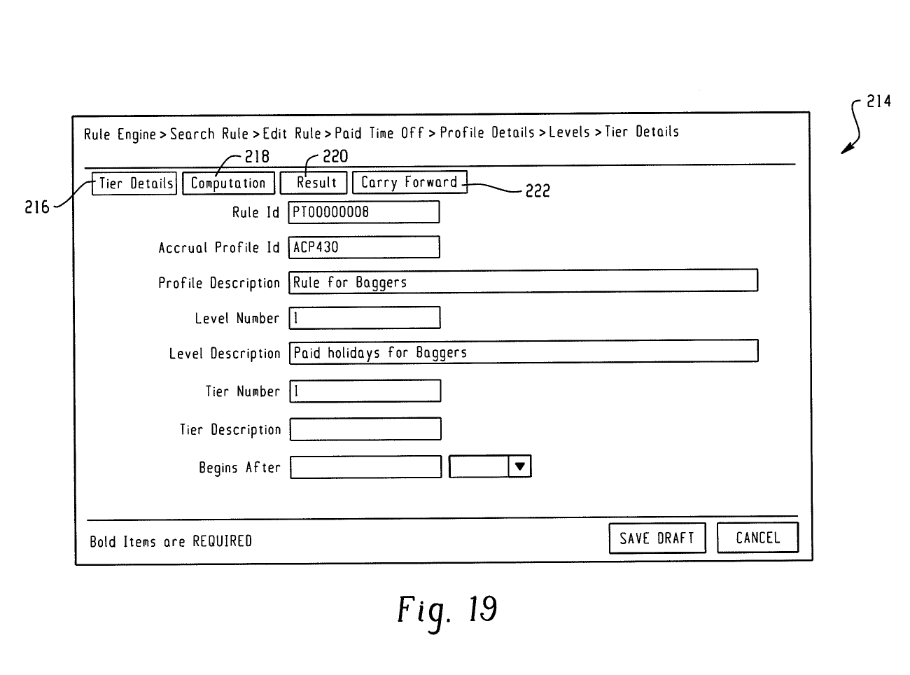

Referring now to FIG. 19, tiers can be added and associated with a level from a Tiers section 212 of the Levels section 188 using Tiers screen 214. The Tiers screen 214 displays four tabs: Tier Details 216, Computation 218, Result 220 and Carry Forward 222. Most of the information displayed under the Tier Details tab 216 is the information entered in the Profile Details and Levels sections.

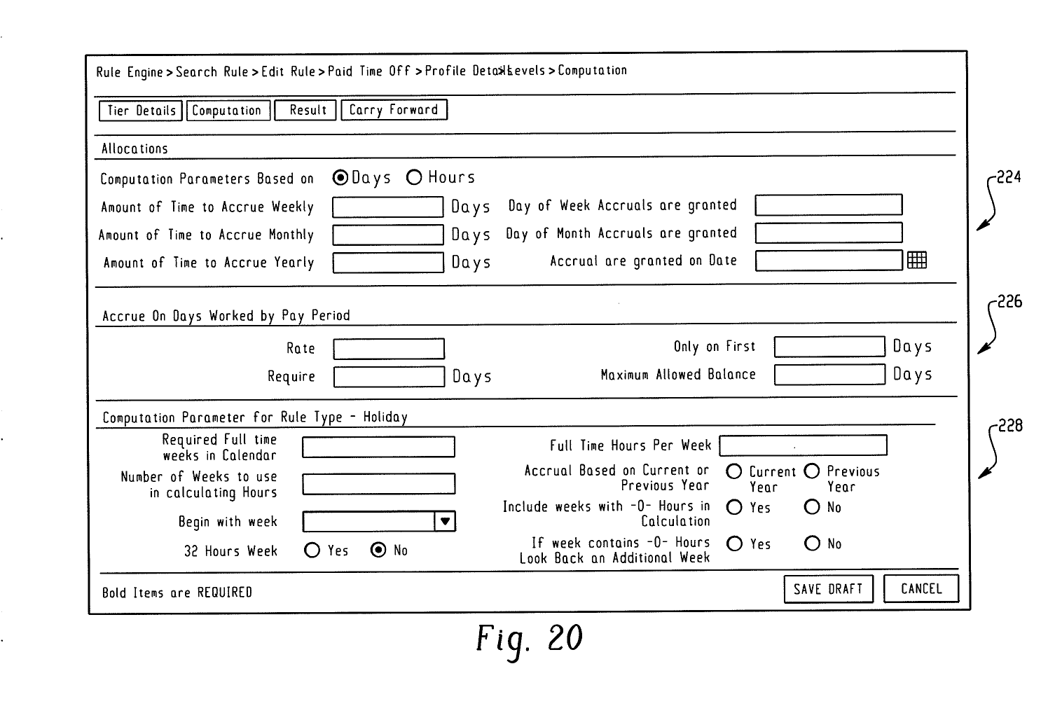

Referring to FIG. 20, Computation Tab 218 includes an Allocations Section 224, an accrue on days worked by Pay Period section 226 and a computation parameter for Rule Type section 228. Each section 224, 226 and 228 includes various fields and buttons for use in further defining the Paid Time Off Rule.

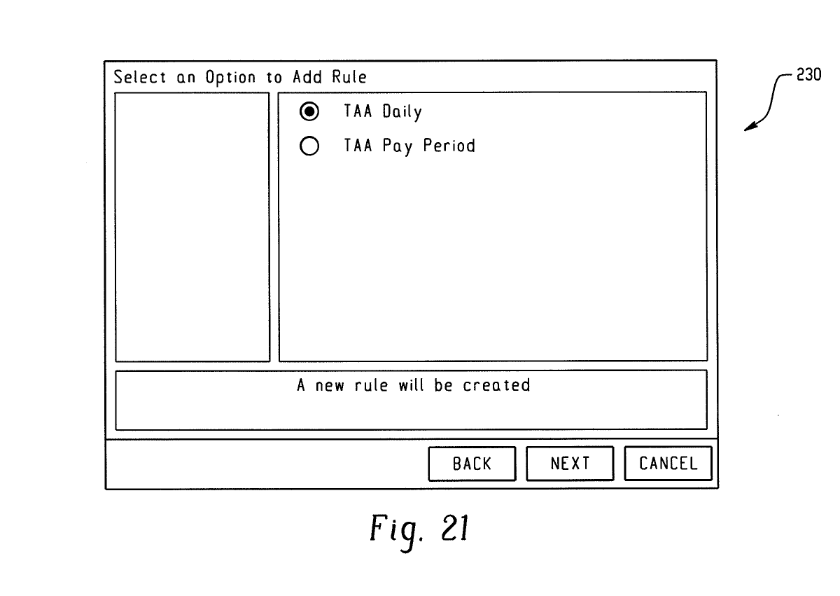

Referring to FIG. 21, the terms and conditions of an employee's work time and the benefits accrued by working regular hours and overtime are captured in Time and Attendance Rules. Time and Attendance Rules—daily and pay period—are added using the Wizard screen 230. Pay Period Rules are rules for the entire pay period, such as weekly overtime limits and consecutive day overtime. Daily rules are rules such as daily overtime, night premiums, holiday premiums, etc.

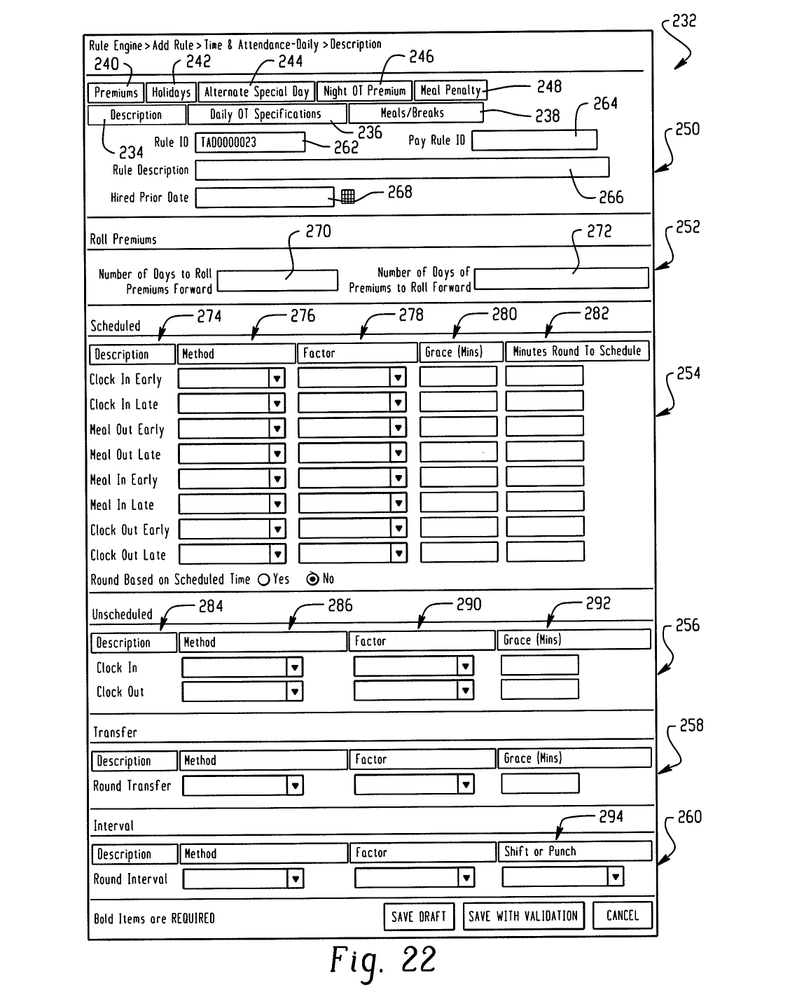

Referring to FIG. 22, a Time and Attendance—Daily Rule can be added using screen 232 and includes a Description tab 234, Daily Overtime Specifications tab 236, Meal/Breaks tab 238, Premiums tab 240, Holidays tab 242, Alternate Special Day tab 244, Night Overtime Premium tab 246, and Meal Penalty tab 248. The illustrated Description tab 234 is divided into a Description section 250, Roll Premiums section 252, Scheduled Section 254, Unscheduled Section 256, Transfer Section 258 and Interval section 260. The Description section 250 includes a rule ID 262 that is automatically generated by the system, a Pay Rule ID 264 that is entered by the contract administrator, a Rule Description field 266 for entering a description of the rule and a hired prior date field 268. The Roll Premiums section 252 allows the contract administrator to enter the number of days ahead to roll forward the existing premium specifications in field 270 and/or the number of days of premium to roll forward in field 272. The Scheduled section 254 includes a description column 274 that displays the names of the scheduled parameters, a method column 276 and a factor column 278 that display a drop-down list against each scheduled parameter, a grace column 280 that is used to determine a number of minutes into a rounding factor that a clock-in is rounded back instead of forward and a minutes to round column 282 that determines a number of minutes (before/after) a scheduled clock-in time in which the punch will be rounded to the employee's scheduled clock-in time. The Unscheduled section 256 includes a description column 284 that displays names of the unscheduled parameters, a method column 286, a factor column 290 that display drop-down lists against each unscheduled parameter and another grace column 292. The transfer section 258 also includes description, method, factor and grace columns. The Interval section 260 includes description, method, factor and a shift or punch column 294 to select from a shift or a punch option from a drop-down list. Once the information is entered, it can be saved and validated or saved as a draft, as described above. Similarly, information can be entered under each Daily Overtime Specifications tab 236, Meal/Breaks tab 238, Premiums tab 240, Holidays tab 242, Alternate Special Day tab 244, Night Overtime Premium tab 246, and Meal Penalty Tab 248, to set parameters for each of these events as Time and Attendance Rules.

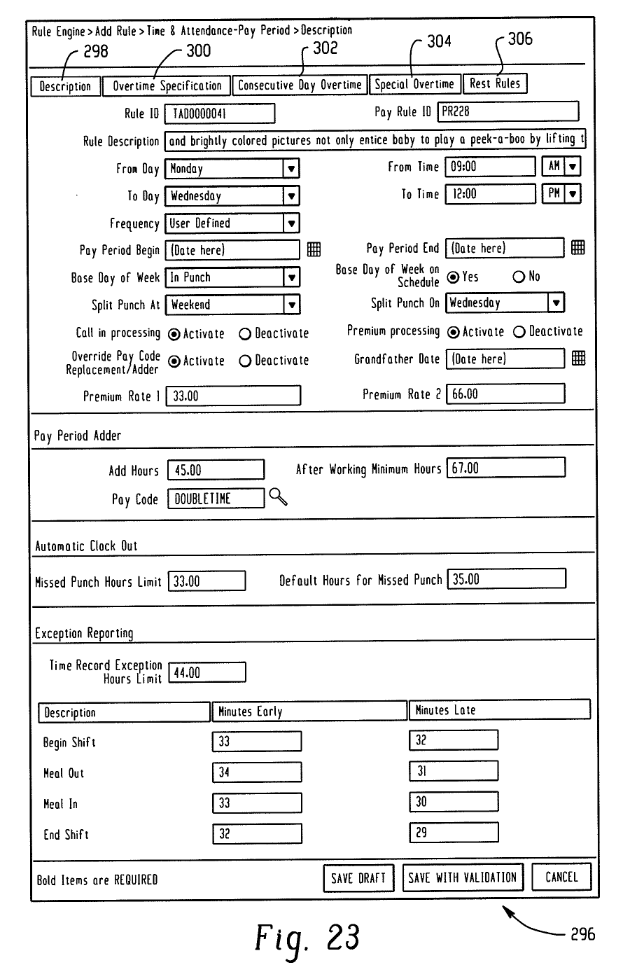

Referring to FIG. 23, a Time and Attendance—Pay Period Rule can be added using screen 296 and includes a Description tab 298, Overtime Specification tab 300, consecutive Day overtime tab 302, Special Overtime tab 304 and Rest Rules tab 306. Similar to Daily Rules described above, information can be entered under each tab, providing parameters for control of Time and Attendance issues on a pay period basis.

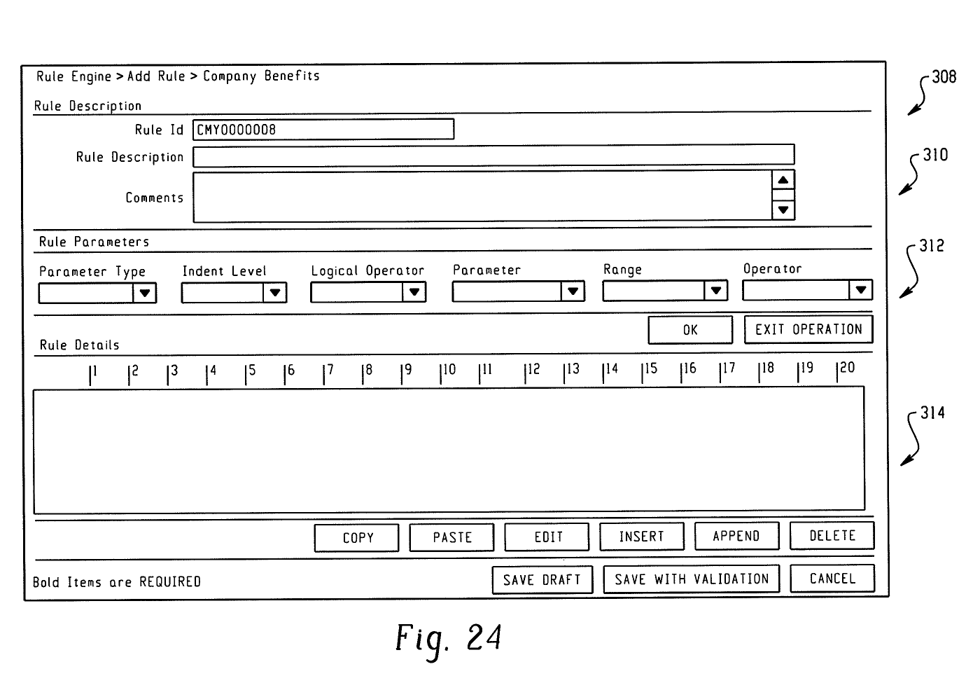

Referring to FIG. 24, in addition to Taft-Hartley funded benefits, the company may also provide company-sponsored benefits to employees. Company Benefit Rules specify the eligibility of an employee or group for such benefits and can be created using Company Benefits Rule screen 308. Similar to UPHW Rules screen 132, the Company Benefits Rule screen 308 includes a Description Section 310, a Rule Parameters section 312 and a Rule Details section 314. The Rules Parameters section 312 has a series of drop-down lists for use in adding rule rows in the rule details section 314. The Company Benefits screen 308 can be used to define rules for eligibility for company-sponsored benefits to a group of employees such as long term disability, medical benefits, dental benefits, vision benefits, 401K plan, group legal benefits, life insurance, auto home insurance, personal accident, stock purchase, pension plan, short term disability, education assistance, etc.

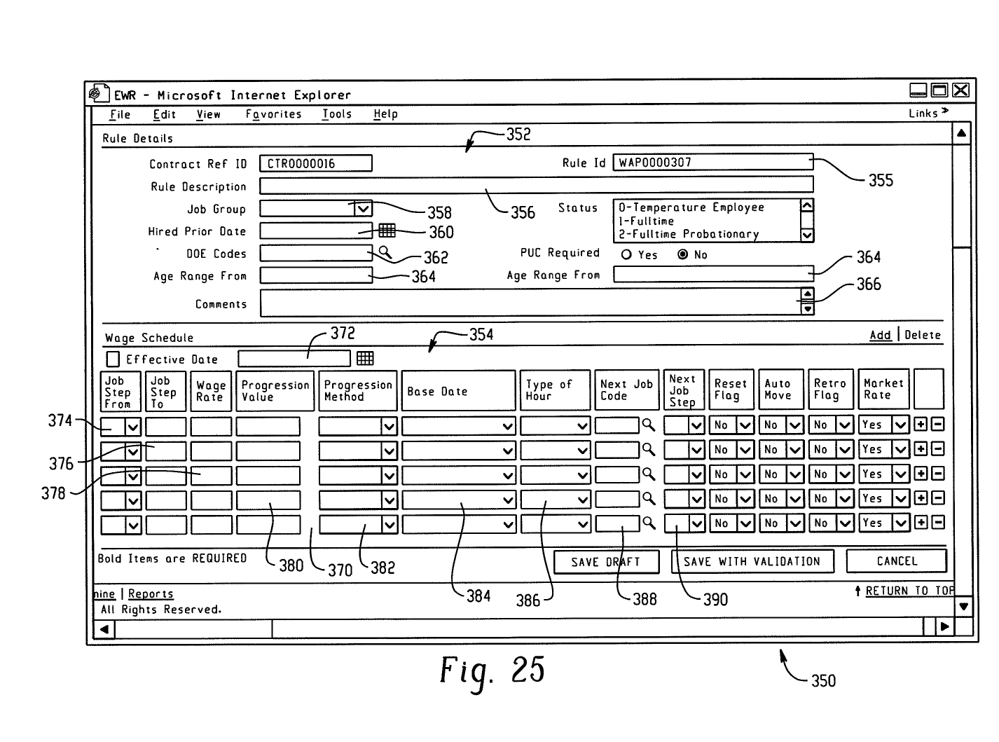

Referring to FIG. 25, a Wage Progression Add/Edit Rule screen 350 is shown. The Wage Progression Add/Edit Rule screen 350 includes a Rule Details section 352 for adding rule details and comments and a Wage Schedule section 354 for determining the wage progression schedules for the selected job group.

The Rule Details section 352 includes a Rule ID field 355, which includes a system generated unique identifier, a Rule Description field 356, which is an input field for entering a rule description. A Job Group drop-down list 358 provides a list of the available job groups to choose from. A Hired Prior Date field 360 can accommodate employees who have been hired prior to a specific date. A Deductions and Earnings Code field 362 allows for selection of a particular DOE code to be excluded. An Age Range From/To field 364 can accommodate employees in a specific age range and a Comments field 366 allows for entry of comments about the Wage Progression Rule. A Status Selection field 357 allows for selection of a particular subset of employees based on employment status such as temporary, fulltime, etc.

The Wage Schedule section 354 allows the contract administrator to decide the wage progression schedules for the selected job group. The wage progression schedule may be based on the number of job steps the employees of the group pass through, the wage rate, progression value and the method of progression. One Wage Schedule grid 370 may display be default and more such grids may be added.

The Wage Schedule section 354 includes an Effective Date field 372, which is the date from which the wage schedule is effective. A Job Step From drop-down list 374 contains the available job steps from which the wage schedule will start. A Job Step To field 376 gets automatically populated with a value that is one less than the Job Step From contained in the next rule row or the highest jobs step available if there is only one row. A Wage Rate field 378 allows for entry of a rate at which the employee will be paid under the wage progression row. A Progression Value field 380 allows for entry of a total number of units an employee must work to qualify for the next job step. A Progression Method drop-down list 382 allows the contract administrator to choose the unit (e.g., hours, days, weeks, months, weeks worked, months worked, calendar date) for the wage progression. A Base Date drop-down list 384 allows the contract administrator to choose the date the progression should start from (e.g., hire date, date of last raise, etc.). A Types of Hours field 386 allows for specification of the type of hours to use to progress to the next step. A Next Job Code field 388 allows for entry of a of a job code and a Next Job Step field 390 allows for entry of a job step from which the next rule row will start.

Reports

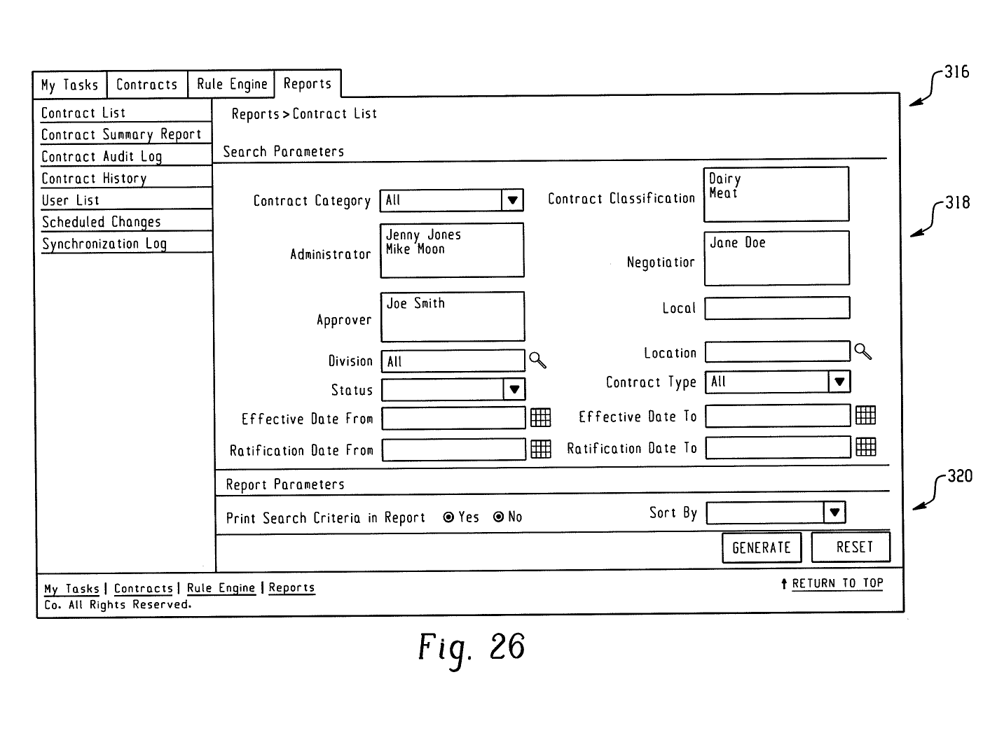

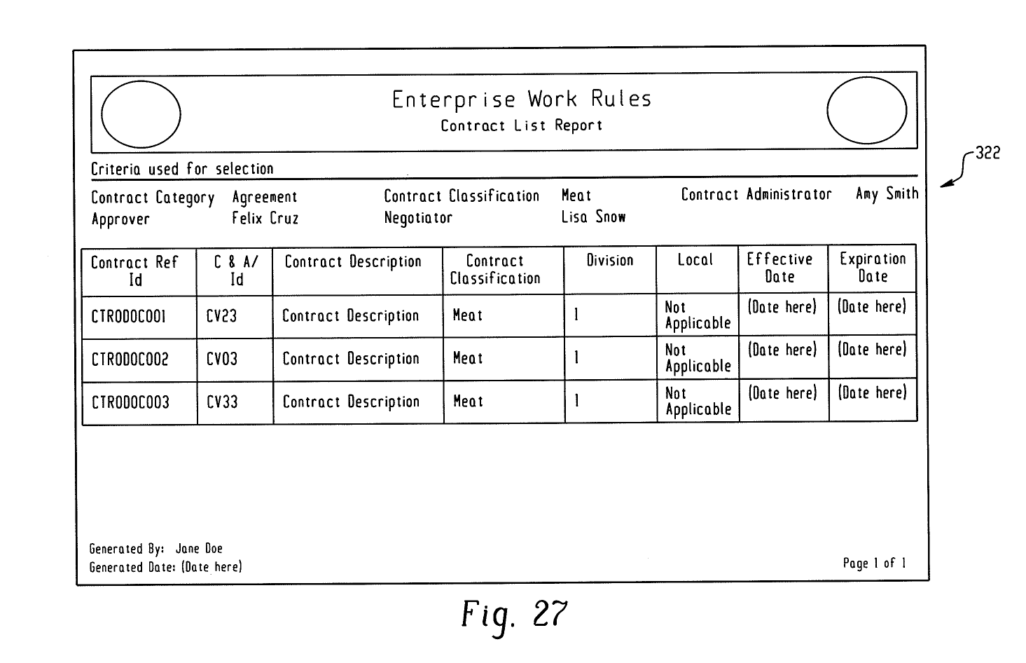

Reports may be generated on various contract activities. Exemplary types of reports include Contract List Reports, Contract Summary Reports, Contract Audit Log Reports, Contract History Reports, Scheduled Changes Reports, User List Reports and Synchronization Log Reports. Referring to FIG. 26, a Contract List Report screen 316 allows a user to obtain a list of contracts belonging, for example, to a particular user or a division, or having some other feature. The Contract List Report screen 316 includes a Search Parameters section 318 and a Report Parameters section 320. Search parameters include contract category, contract classification, administrator, negotiator, approver, local, division, location, status (e.g., active, inactive, in progress, etc.), contract type, effective date and expiration date. Report parameters include print search criteria in report (allows a user to print the search parameters with report), and sort by (e.g., contract reference ID, contract description, local, etc.). FIG. 27 illustrates an exemplary Contract List Report 322.

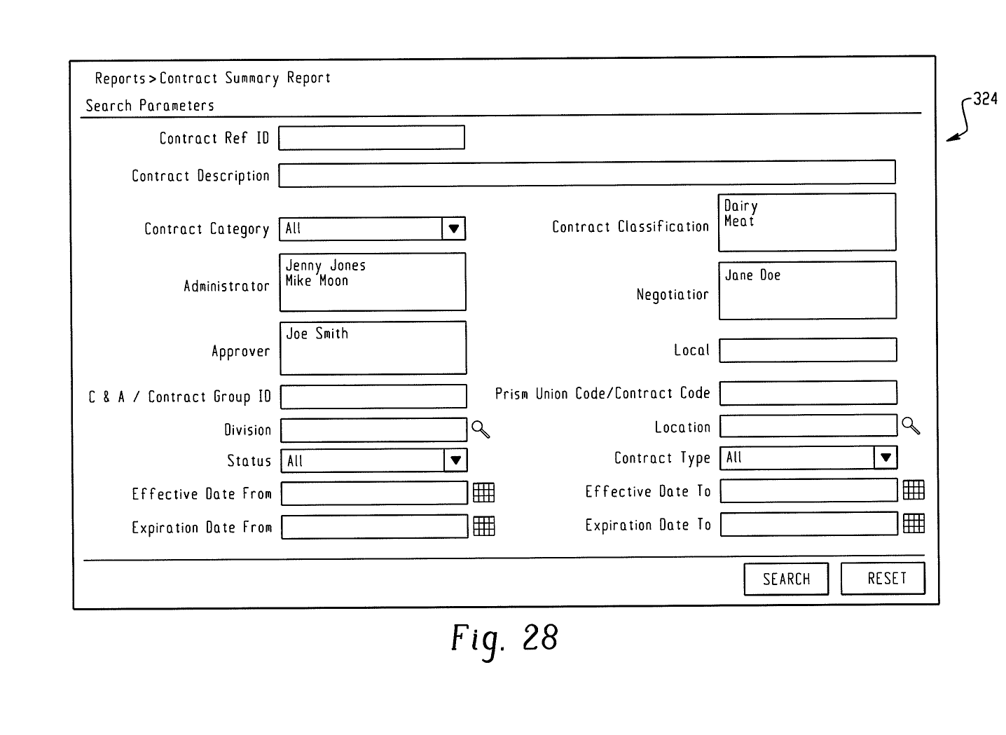

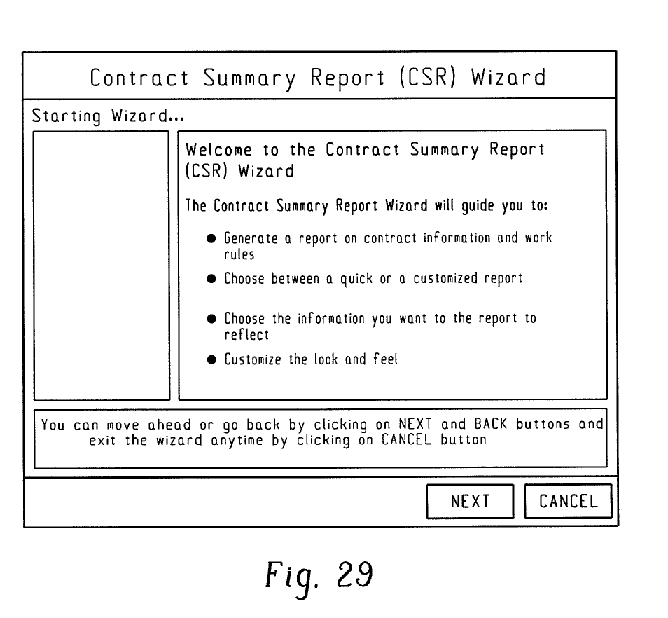

Another type of report is a Contract Summary Report. A Contract Summary Report is a comprehensive report that covers all details of the contract such as basic information and rules associated with the contract, including all data elements and parameters within every rule. FIG. 28 illustrates a Contract Summary Report Search screen 324 for use in finding a particular electronic contract. Once an electronic contract is identified, referring to FIG. 29, a Contract Summary Report wizard helps the user generate the report.

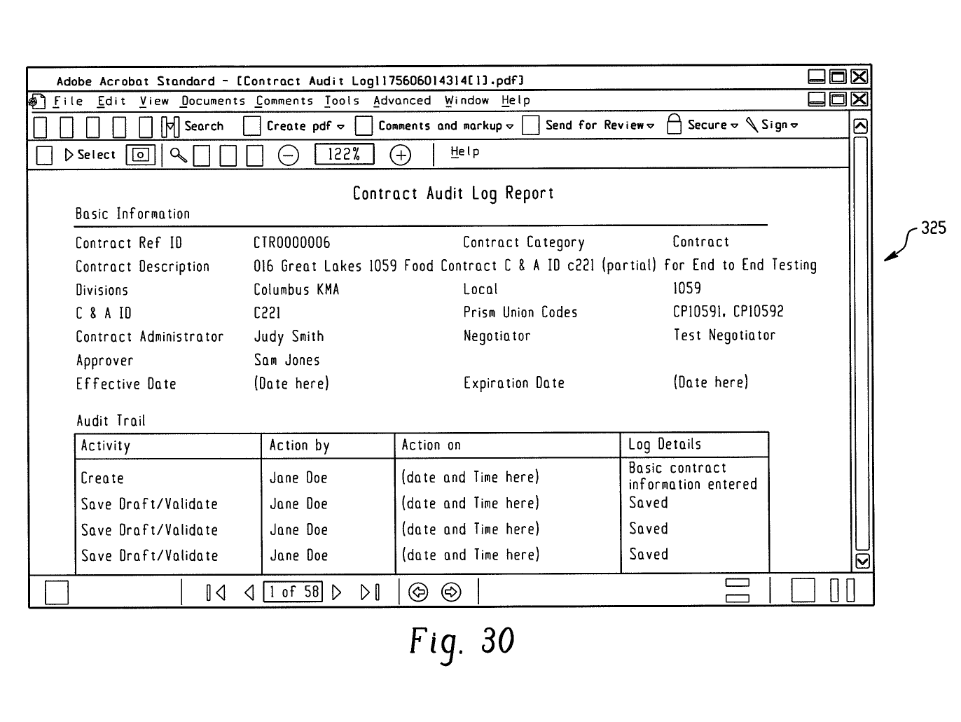

Referring to FIG. 30, a Contract Audit Log Report 325 allows users to generate and view details of modifications carried out on an electronic contract, providing an audit trail of changes made and who made the changes. A particular electronic contract is identified using a search screen similar to that of FIG. 28.

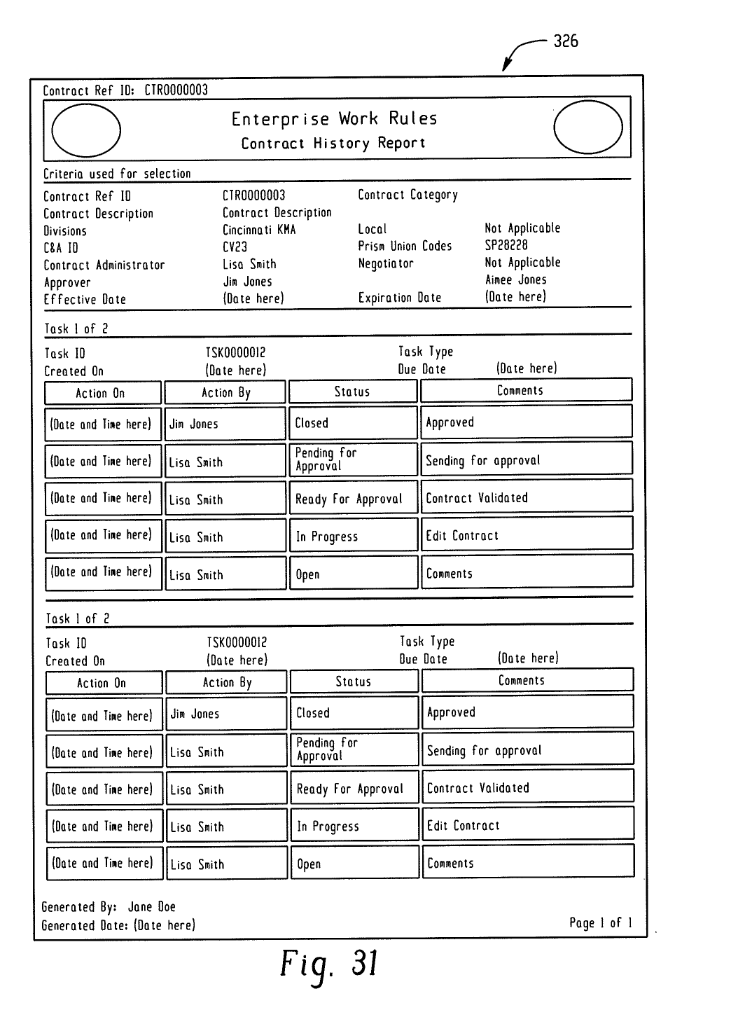

A Contract History Report allows users to generate a report of a task history of an electronic contract. A particular electronic contract is identified using a search screen similar to that of FIG. 28. FIG. 31 illustrates an exemplary Contract History Report 326.

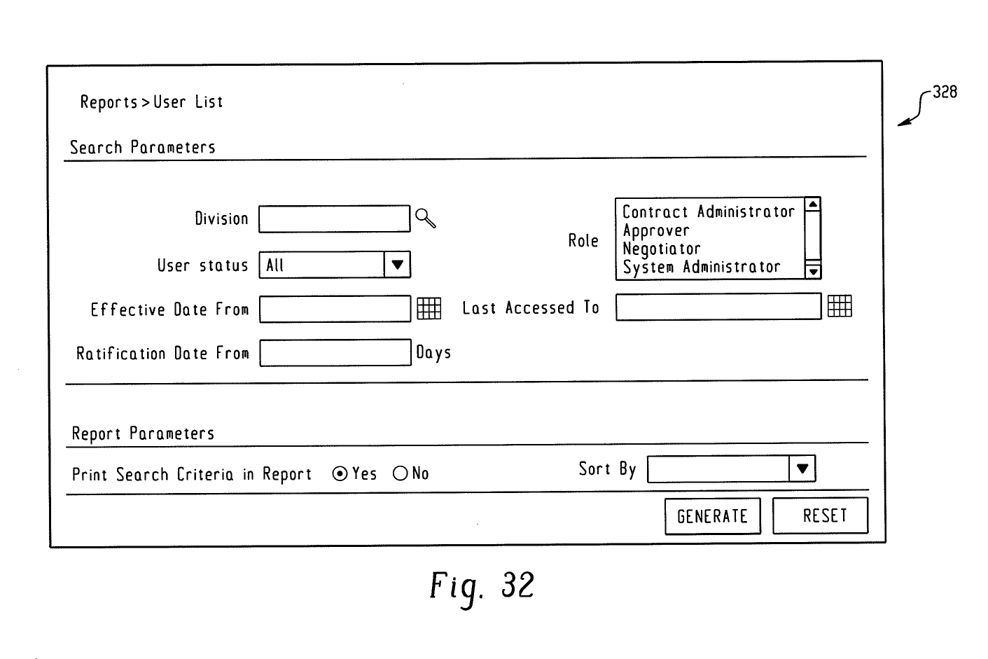

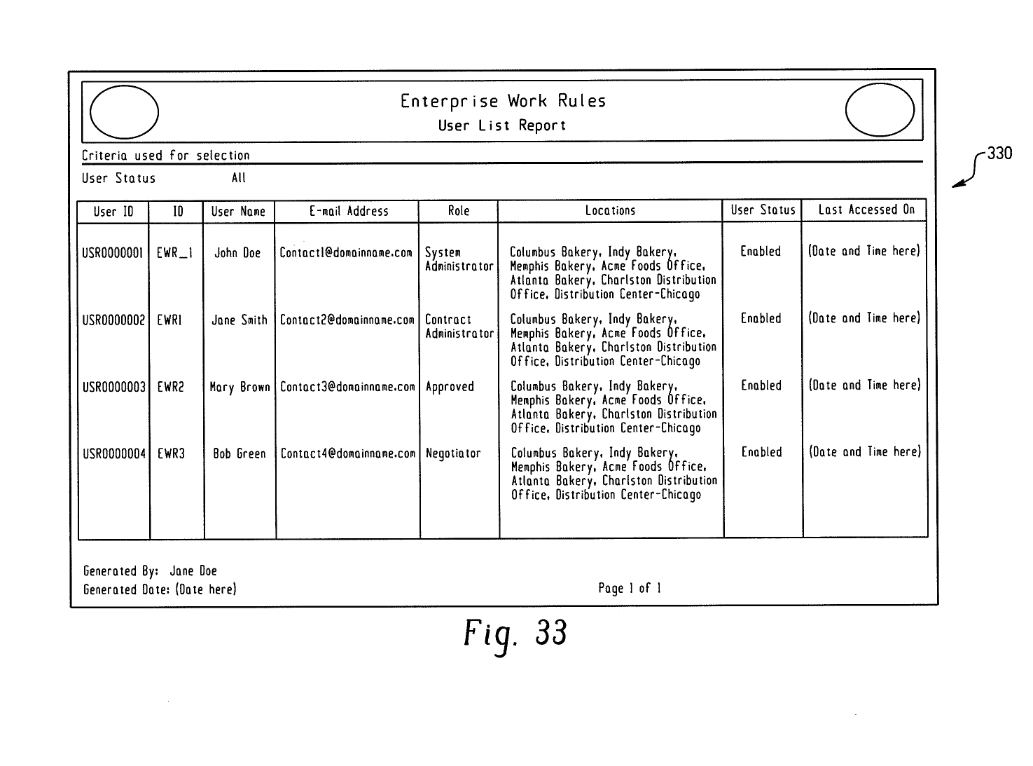

A User List Report allows users to generate a report of details of a particular user or group of users. FIG. 32 illustrates a search screen 328 for identifying user(s) and FIG. 33 illustrates an exemplary User List Report 330.

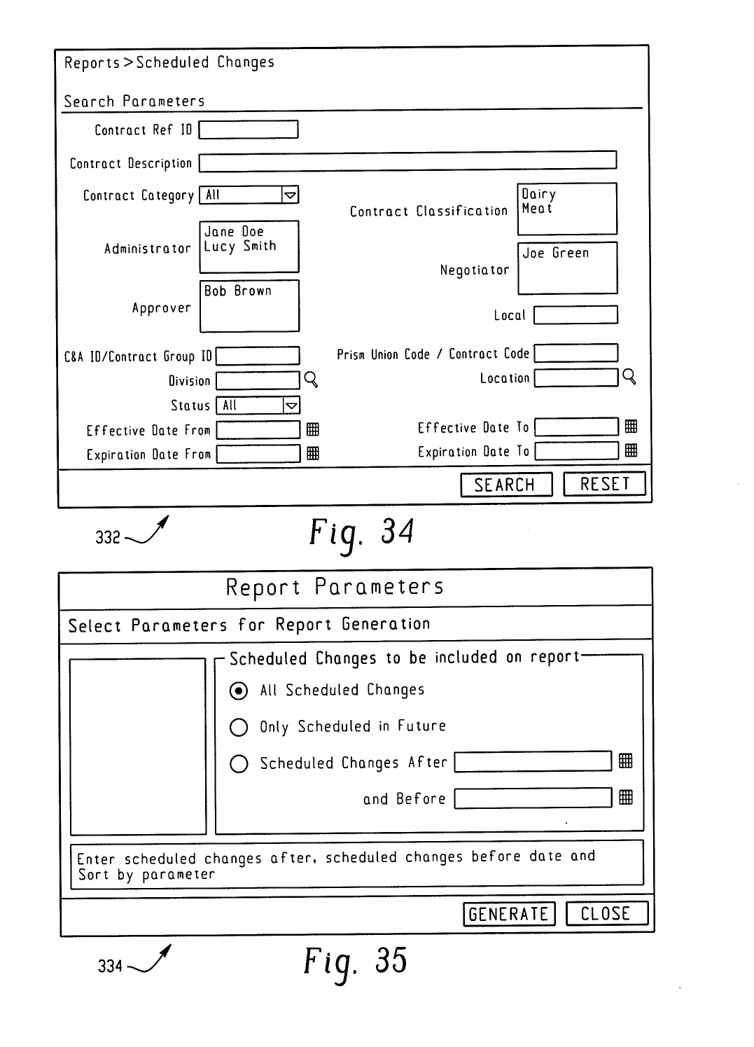

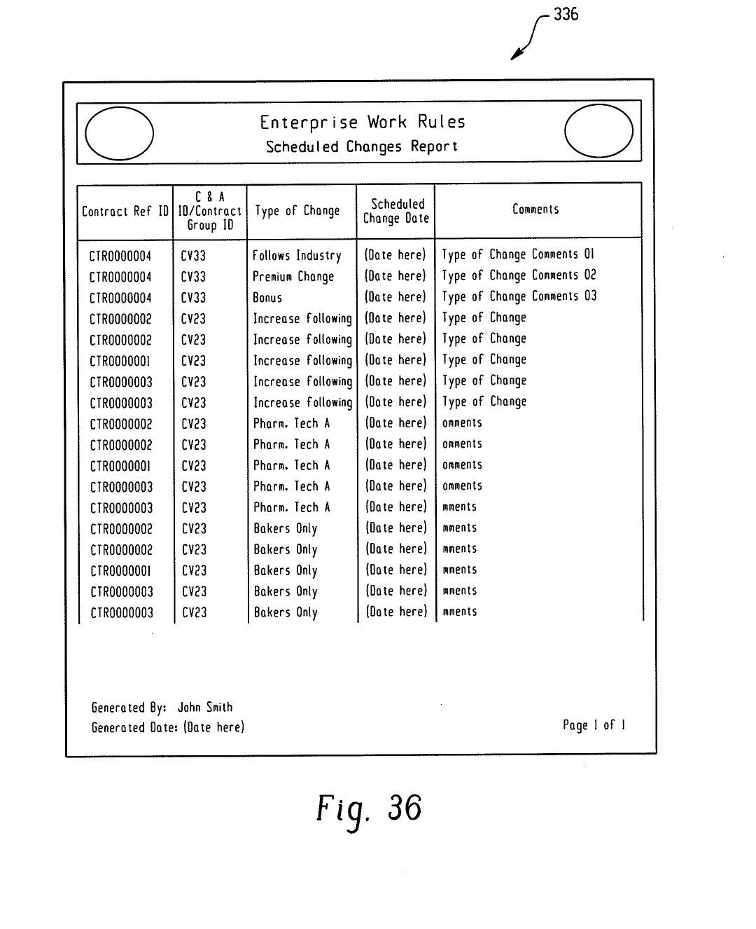

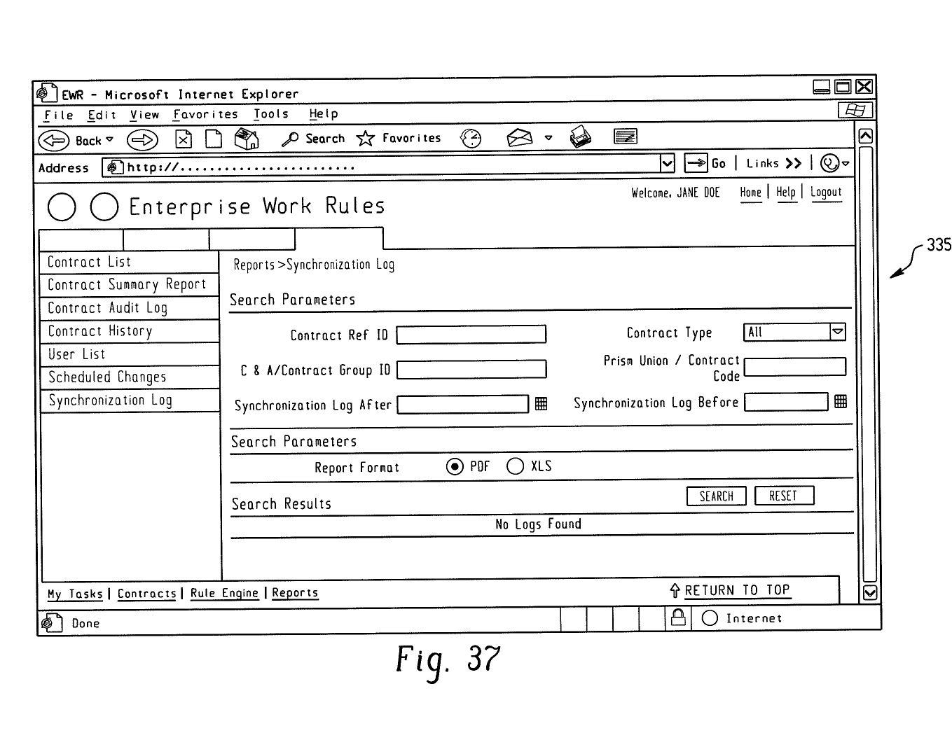

A Scheduled Changes Report allows users to generate a report of all scheduled changes defined in an electronic contract or a group of electronic contracts. FIG. 34 shows a search screen 332 for identifying an electronic contract. Once an electronic contract is identified and selected, referring to FIG. 35, a Wizard screen 334 allows the user to select various reporting parameters, such as all scheduled changes. FIG. 36 illustrates an exemplary Scheduled Changes Report 336 that includes type of change associated with a particular electronic contract and scheduled change date.

Referring to FIG. 37, a Synchronization Log Report 335 shows a history of successful exports of created electronic contracts, for example, to a payroll system or imports of contracts from a payroll system.

System Administration

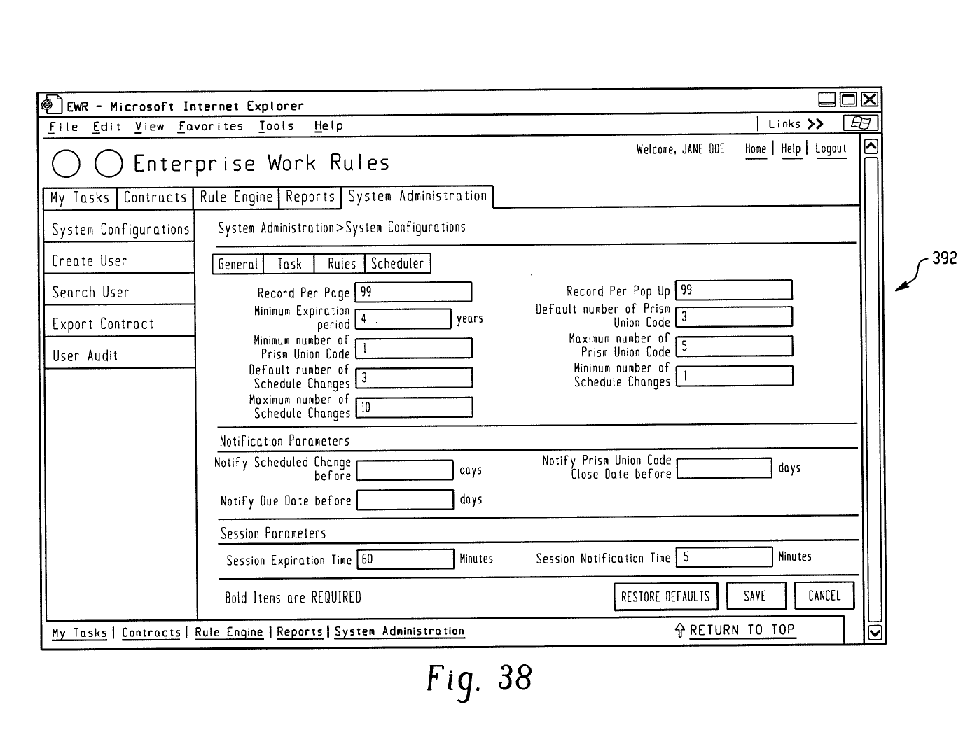

Referring to FIG. 38, a System Configurations screen 392 is illustrated for system administration, for example, by a system administrator having administrative rights. Various tasks may be assigned to the system administrator having the appropriate administrative rights. In addition, tasks such as creating and deleting users, deciding display properties, exporting electronic contracts, deleting and restoring electronic contracts and rules can be accomplished by the system administrator.

System Architecture

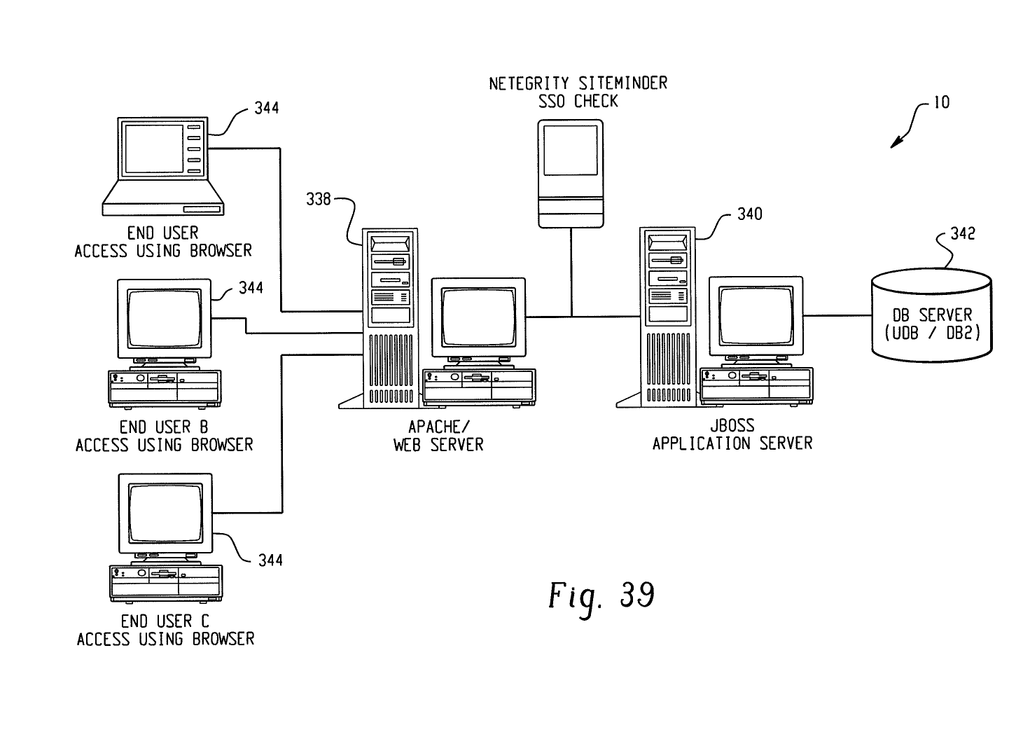

The above-described management system 10 may be implemented using any suitable architecture. In some embodiments, referring to FIG. 39, management system 10 is implemented using a web server 338 (e.g., an Apache Web Server pre-configured on an IBM X335 machine utilizing the Red Hat Linux Enterprise Edition 3.0 operating system) and an application server 340 (e.g., a Jboss 4.0.3 sp1 server). A suitable database server 342 is a DB2 UDB Enterprise Server Edition 8.1.6. The database server 342 serves as a single repository for the contract data. The web server 338 communicates with user workstations 344.

While particular embodiments of the present invention have been illustrated and described, it would be obvious to those skilled in the art that various additional changes and modifications can be made without departing from the spirit and scope of the present invention. It is therefore intended to cover in the appended claims all such changes and modifications that are within the scope of this invention.

What is claimed:

1. A computer-assisted management method for an enterprise including multiple work locations, the method comprising:
creating electronic contracts by associating work rules within the electronic contracts, the work rules governing an employer-employee relationship;
storing the electronic contracts including the work rules in a contract database;
providing the electronic contracts stored in the contract database to one or more system; and
managing the employer-employee relationship using the electronic contracts including the work rules.

2. The method of claim 1, wherein the work rule is defined by a labor contract.

3. The method of claim 1, wherein the work rule is defined by a comp any policy.

4. The method of claim 1, wherein the one or more system is a payroll management system, the step of managing the employer-employee relationship comprising administering employee compensation and/or benefits using the electronic contracts including the work rules.

5. The method of claim 4, further comprising creating a wage progression rule.

6. The method of claim 1, wherein the step of associating a work rule with the electronic contracts includes creating a status progression rule.

7. The method of claim 1, wherein the step of associating a work rule with the electronic contracts includes creating a paid time off rule.

8. The method of claim 1, wherein the step of associating a work rule with the electronic contracts includes creating a time and attendance rule.

9. The method of claim 1 further comprising generating a report listing data associated with the electronic contracts.

10. The method of claim 9, wherein the report is a contract audit log report for viewing details of modifications carried out on the electronic contract including an audit trail of changes to the electronic contract.

11. The method of claim 1 further comprising approving the electronic contracts by an approver, wherein a contract administrator creates the electronic contracts, the contract administrator being different from the approver.

12. A computer-assisted management method for an enterprise including multiple work locations, the method comprising:
generating a first task for a contract administrator, the contract administrator creating an electronic contract in response to the first task;
generating a second task for an approver who is different from the contract administrator, the approver approving the electronic contract created by the contract administrator in response to the second task; and
storing the electronic contract in a contract database.

13. The method of claim 12 further comprising associating a work rule with the electronic contract and saving the work rule in the contract database.

14. The method of claim 13 further comprising testing the work rule by providing the work rule to a peripheral system.

15. The method of claim 12, wherein the step of generating the first task for the contract administrator is performed by a negotiator who is different from the contract administrator and the approver.

16. The method of claim 12 further comprising generating a report listing data associated with the electronic contract.

17. The method of claim 12, wherein the first task comprises an electronic message to the contract administrator providing an indication that an agreement has been negotiated.

18. The method of claim 12, wherein the second task comprises an electronic message to the approver providing an indication that the electronic contract data is ready for approval.

19. A computerized employee management method for an enterprise including multiple locations, comprising:
(a) for a contract:
(i) storing contract data in an electronic contract database thereby generating an electronic contract;
(ii) associating the contract data with an enterprise hierarchy so as to define to which enterprise locations and enterprise employees the contract data apply;
(b) linking the electronic contract database with an employee on-boarding application to facilitate proper classification of new enterprise employees within the applicable electronic contract;
(c) linking the electronic contract database with one or more enterprise payroll systems to facilitate appropriate payroll management for enterprise employees according to the applicable electronic contract.

20. The computerized employee management method of claim 19, further comprising:
(d) linking the electronic contract database with at least one enterprise time and attendance system to provide appropriate time and attendance rules for employees according to the applicable electronic contract.
